(19) United States
(12) Patent Application Publication
(10) Pub. No.: US 2026/0318756 A1
(43) Pub. Date: Oct. 15, 2026

(54) Pressure Sensor, Manufacturing Method Therefor, and Pressure Sensing Assembly

(71) Applicants: Beijing BOE Sensor Technology Co., Ltd., Beijing (CN); BOE Technology Group Co., Ltd., Beijing (CN); Beijing BOE Technology Development Co., Ltd., Beijing (CN)

(72) Inventors: Weilong GUO, Beijing (CN); Yue LI, Beijing (CN); Qiuxu WEI, Beijing (CN); Lihui WANG, Beijing (CN); Nana HE, Beijing (CN); Taonan ZHANG, Beijing (CN); Jie SUN, Beijing (CN); Wenbo CHANG, Beijing (CN); Hanqing LIU, Beijing (CN); Ding DING, Beijing (CN)

(21) Appl. No.: 18/996,954

(22) PCT Filed: Dec. 26, 2023
(86) PCT No.: PCT/CN2023/141987

§ 371 Date: Jan. 17, 2025

(51) Int. Cl. G01L 1/14

(52) U.S. Cl. CPC G01L 1/142

(57) ABSTRACT

A pressure sensor, a manufacturing method therefor, and a pressure sensing assembly are provided. The pressure sensor includes a base substrate and at least one capacitor provided on the base substrate. One of the at least one capacitor includes a first electrode and a second electrode provided opposite to each other and insulated from each other. The second electrode is located on a side of the first electrode away from the base substrate, and a cavity is provided between the first electrode and the second electrode. An orthographic projection of the first electrode on the base substrate is at least partially overlapped with an orthographic projection of the second electrode on the base substrate, and an orthographic projection of an overlapping region of the first electrode and the second electrode on the base substrate is at least partially overlapped with an orthographic projection of the cavity on the base substrate.

### CROSS-REFERENCE TO RELATED APPLICATION

The present application is a U.S. National Phase Entry of International Application No. PCT/CN2023/141987 having an international filing date of Dec. 26, 2023, the entire content of which is hereby incorporated by reference.

### TECHNICAL FIELD

The present disclosure relates to, but is not limited to, the technical field of sensors, in particular to a pressure sensor, a manufacturing method therefor, and a pressure sensing assembly.

### BACKGROUND

As a device that can convert pressure signals into electrical signals, pressure sensors have been widely used in consumer electronics, medical monitoring, industrial control, automotive electronics, aerospace and other fields. In micro-electro-mechanical systems, pressure sensors can be divided into absolute pressure sensors, gauge pressure sensors and differential pressure sensors according to the output pressure value. The absolute pressure sensors are used to output pressure a value relative to a vacuum, the gauge pressure sensors are used to output a pressure value after deducting atmospheric pressure, and the differential pressure sensors are used to output a pressure difference.

For the absolute pressure sensors, they can be mainly divided into piezoresistive type and capacitive type according to the signal conversion form. The technical principle of the capacitive absolute pressure sensor is to use the capacitive effect to convert a pressure signal into a corresponding electrical signal, that is, a capacitor is formed using two parallel and opposing low-resistance films (an upper plate and a lower plate), and under action of a pressure, the upper plate deforms, causing a change in a relative spacing between the upper plate and the lower plate, which in turn leads to a change in the capacitor.

### SUMMARY

The following is a summary of subject matter described in the present disclosure in detail. This summary is not intended to limit the protection scope of claims.

In a first aspect, the present disclosure provides a pressure sensor, including a base substrate and at least one capacitor provided on the base substrate. One capacitor of the at least one capacitor includes a first electrode and a second electrode provided opposite to each other and insulated from each other, the second electrode is located on a side of the first electrode away from the base substrate, and a cavity is provided between the first electrode and the second electrode.

An orthographic projection of the first electrode on the base substrate is at least partially overlapped with an orthographic projection of the second electrode on the base substrate, and an orthographic projection of an overlapping region of the first electrode and the second electrode on the base substrate is at least partially overlapped with an orthographic projection of the cavity on the base substrate.

The second electrode is provided around the cavity to form a side wall, and is at least partially provided around a surface of the cavity away from the first electrode.

In an exemplary embodiment, the first electrode is formed within the base substrate and is located on a surface of the base substrate.

In an exemplary embodiment, the second electrode is provided with a release hole array, and the release hole array includes release holes arranged in an array.

An orthographic projection of the release hole array on the base substrate is within a range of the orthographic projection of the cavity on the base substrate.

In an exemplary embodiment, the second electrode includes a first sub-electrode and a second sub-electrode connected with each other, and the first sub-electrode and the second sub-electrode are provided in a same layer.

An orthographic projection of the first sub-electrode on the base substrate is not overlapped with an orthographic projection of the second sub-electrode on the base substrate, the first sub-electrode is provided around the side wall of the cavity, the second sub-electrode is provided on a side of the cavity away from the base substrate, the orthographic projection of the cavity on the base substrate is at least partially overlapped with a range of an orthographic projection of the second sub-electrode on the base substrate, and the release hole array is provided on the second sub-electrode.

In an exemplary embodiment, the second electrode includes a first sub-electrode and a second sub-electrode connected with each other, the second sub-electrode includes a first sub-connection portion and a second sub-connection portion, and the first sub-electrode is located on a side of the second sub-electrode close to the base substrate.

An orthographic projection of the first sub-electrode on the base substrate is at least partially overlapped with an orthographic projection of the second sub-electrode on the base substrate, the first sub-electrode is provided around the side wall of the cavity, and the second sub-electrode is provided on a side of the cavity away from the base substrate.

An orthographic projection of the first sub-connection portion on the base substrate is at least partially overlapped with the orthographic projection of the first sub-electrode on the base substrate, the orthographic projection of the cavity on the base substrate is at least partially overlapped with a range of an orthographic projection of the second sub-connection portion on the base substrate, and the release hole array is provided on the second sub-connection portion. In an exemplary embodiment, the pressure sensor further includes an insulating dielectric layer provided between the first electrode and the second electrode of the at least one capacitor. In an exemplary embodiment, the pressure sensor further includes a sealing layer at least partially located on a side of the second electrode of the at least one capacitor away from the base substrate.

An orthographic projection of the cavity of the at least one capacitor on the base substrate is located within a range of an orthographic projection of the sealing layer on the base substrate, and the sealing layer is at least partially filled in the release holes.

In an exemplary embodiment, a boundary of the cavity is in contact with the insulating dielectric layer, the second electrode, and the sealing layer.

In an exemplary embodiment, the sealing layer includes a first sealing structure and a second sealing structure, and the first sealing structure and the second sealing structure are of an integral structure.

The first sealing structure is located on a side of the second electrode away from the base substrate, and at least partially filled in the release holes, the orthogonal projection of the cavity of the at least one capacitor on the base substrate is located within a range of an orthogonal projection of the first sealing structure on the base substrate, the second sealing structure is located between the second electrode and the insulating dielectric layer, and the cavity is formed in the second sealing structure.

In an exemplary embodiment, the pressure sensor further includes a sealing layer and a plurality of bonding pads. The sealing layer is located on a side of the second electrode of the at least one capacitor away from the base substrate, and the plurality of bonding pads are located on a side of the sealing layer away from the base substrate.

The plurality of bonding pads are respectively connected with the first electrode and the second electrode of the at least one capacitor.

In an exemplary embodiment, the pressure sensor further includes an adhesive layer. The adhesive layer includes a plurality of adhesive structures, the sealing layer is provided with a plurality of grooves, the plurality of adhesive structures are one-to-one corresponding to the plurality of grooves and one-to-one corresponding to the plurality of bonding pads, and an adhesive structure is provided in a corresponding groove and connected with a corresponding bonding pad.

The adhesive layer includes a conductive film layer, and a resistivity of a material for making the adhesive layer is greater than a resistivity of a material for making the bonding pads.

In an exemplary embodiment, the at least one capacitor includes a pressure sensing capacitor, and the plurality of bonding pads include a first bonding pad and a second bonding pad.

First bonding pads are respectively connected with the first electrode of the pressure sensing capacitor, and second bonding pads are respectively connected with the second electrode of the pressure sensing capacitor.

In an exemplary embodiment, the at least one capacitor includes at least one pressure sensing capacitor and at least one reference capacitor, and a deformation rate of the second electrode of a reference capacitor under pressure is 0.1% to 0.3% of a deformation rate of the second electrode of a pressure sensing capacitor under pressure.

A quantity of release holes included in the release hole array of the second electrode of the pressure sensing capacitor is the same as a quantity of release holes included in the release hole array of the second electrode of the reference capacitor, or a quantity of release holes included in the release hole array of the second electrode of the pressure sensing capacitor is greater than a quantity of release holes included in the release hole array of the second electrode of the reference capacitor.

The first electrode of the at least one pressure sensing capacitor and the first electrode of the at least one reference capacitor are provided in a same layer, and the second electrode of the at least one pressure sensing capacitor and the second electrode of the at least one reference capacitor are provided in a same layer.

In an exemplary embodiment, in a state where the quantity of release holes included in the release hole array of the second electrode of the pressure sensing capacitor is the same as the quantity of release holes included in the release hole array of the second electrode of the reference capacitor, and the pressure sensor further includes a pressure-resistant layer located on a side of the sealing layer away from the base substrate.

An orthographic projection of the at least one reference capacitor on the base substrate is located within a range of an orthographic projection of the pressure-resistant layer on the base substrate, the pressure-resistant layer is provided with at least one pressure sensing hole that exposes the sealing layer, the at least one pressure sensing hole is one-to-one corresponding to the at least one pressure sensing capacitor, and an orthographic projection of a pressure sensing hole on the base substrate is at least partially overlapped with an orthographic projection of the second electrode of a corresponding pressure sensing capacitor on the base substrate.

In an exemplary embodiment, in a state where the quantity of release holes included in the release hole array of the second electrode of the pressure sensing capacitor is greater than the quantity of release holes included in the release hole array of the second electrode of the reference capacitor, the at least one reference capacitor further includes a support structure provided between the second electrode of the at least one reference capacitor and the insulating dielectric layer.

An orthographic projection of the support structure on the base substrate is at least partially overlapped with an orthographic projection of the second electrode of the reference capacitor on the base substrate, and the cavity of the reference capacitor is provided around the support structure.

In an exemplary embodiment, when a quantity of pressure sensing capacitor is one and a quantity of reference capacitor is one, the plurality of bonding pads include a first bonding pad, a second bonding pad, and a third bonding pad.

First bonding pads are respectively connected with the second electrode of the pressure sensing capacitor, second bonding pads are respectively connected with the second electrode of the reference capacitor, and third bonding pads are respectively connected with the first electrode of the pressure sensing capacitor and the first electrode of the reference capacitor.

In an exemplary embodiment, when a quantity of pressure sensing capacitor is two and a quantity of reference capacitor is two, the plurality of bonding pads include a first bonding pad, a second bonding pad, a third bonding pad, and a fourth bonding pad.

The first bonding pad is respectively connected with the second electrode of a first pressure sensing capacitor and the second electrode of a first reference capacitor, the second bonding pad is respectively connected with the second electrode of a second pressure sensing capacitor and the second electrode of a second reference capacitor, the third bonding pad is respectively connected with the first electrode of the first pressure sensing capacitor and the first electrode of the second reference capacitor, and the fourth bonding pad is respectively connected with the first electrode of the first reference capacitor and the first electrode of the second pressure sensing capacitor.

In an exemplary embodiment, the first pressure sensing capacitor, the second reference capacitor, the second pressure sensing capacitor and the second reference capacitor are provided in one direction.

In an exemplary embodiment, an area of a surface of the cavity in the at least one capacitor close to the second electrode is within a range of 20 to 100 times a thickness of the cavity.

In an exemplary embodiment, it further includes at least one of a sealing layer, an adhesive layer, a bonding pad layer, a pressure-resistant layer, and a support structure.

A material for making the base substrate includes monocrystalline silicon.

A material for making the first electrode includes monocrystalline silicon doped with ions, and the ions include boron, phosphorus and arsenic.

A material for making the second electrode includes low-resistance polysilicon or a metal. A material for making the insulating dielectric layer includes silicon oxide or silicon nitride.

A material for making the sealing layer and the pressure-resistant layer includes at least one of silicon oxide and silicon nitride.

A material for making the bonding pad layer includes aluminum or gold.

A material for making the adhesive layer includes titanium, chromium or tantalum.

A material for making the support structure includes silicon oxide, low temperature glass, phosphosilicate glass or polysilicon.

In a second aspect, the present disclosure further provides a pressure sensing assembly, including the above-mentioned pressure sensors arranged in an array.

In a third aspect, the present disclosure further provides a method for manufacturing a pressure sensor configured to manufacture the above-mentioned pressure sensor, the method includes:
forming a first electrode of at least one capacitor;
forming a second electrode of the at least one capacitor; and
forming a cavity between the first electrode and the second electrode of the at least one capacitor.

In an exemplary embodiment, forming the first electrode of the at least one capacitor includes:
providing a base substrate; and
implanting ions into a partial region of the base substrate to form the first electrode of the at least one capacitor.

In an exemplary embodiment, before forming the second electrode of the at least one capacitor, the method further includes forming an insulating dielectric layer on the first electrode of the at least one capacitor.

In an exemplary embodiment, after forming the cavity between the first electrode and the second electrode of the at least one capacitor, the method further includes:

forming a sealing layer on the second electrode of the at least one capacitor by a patterning process.

In an exemplary embodiment, forming the second electrode of the at least one capacitor includes:
forming a sacrificial layer on the insulating dielectric layer by a patterning process; and
forming the second electrode of the at least one capacitor on the sacrificial layer by a patterning process, the second electrode of the at least one capacitor being provided with a release hole array.

In an exemplary embodiment, forming the cavity between the first electrode and the second electrode of the at least one capacitor includes:
etching the sacrificial layer by an etchant through the release hole array to form the cavity.

In an exemplary embodiment, forming the second electrode of the at least one capacitor includes:
forming a sacrificial layer on the insulating dielectric layer;
implanting ions into a partial region of the sacrificial layer to form a first sub-electrode of the second electrode of the at least one capacitor, wherein the ions include boron, phosphorus, and arsenic, and an implanting dose is in a range of 3E15 per square centimeter to 1E16 per square centimeter; and
forming a second sub-electrode of the second electrode of the at least one capacitor by a patterning process, wherein the second sub-electrode is provided with a release hole array, and an orthographic projection of the release hole array on the base substrate is partially overlapped with an orthographic projection of the sacrificial layer which is not ion-implanted on the base substrate.

In an exemplary embodiment, forming the cavity between the first electrode and the second electrode of the at least one capacitor includes:
etching the sacrificial layer which is not ion-implanted by an etchant through the release hole array to form the cavity.

In an exemplary embodiment, after forming the cavity between the first electrode and the second electrode of the at least one capacitor, the method further includes:
forming a plurality of bonding pads on the sealing layer by a patterning process.

In an exemplary embodiment, after forming the cavity between the first electrode and the second electrode of the at least one capacitor, the method further includes:
forming an adhesive layer and a plurality of bonding pads on the sealing layer by a patterning process in sequence.

In an exemplary embodiment, when the pressure sensor includes at least one pressure sensing capacitor and at least one reference capacitor, the method further includes forming a pressure-resistant layer on the plurality of bonding pads by a patterning process. The pressure-resistant layer is provided with at least one pressure sensing hole, the at least one pressure sensing hole is one-to-one corresponding to the at least one pressure sensing capacitor, and an orthographic projection of a pressure sensing hole on the base substrate is at least partially overlapped with an orthographic projection of the second electrode of a corresponding pressure sensing capacitor on the base substrate

In an exemplary embodiment, when the pressure sensor includes at least one pressure sensing capacitor and at least one reference capacitor, the method further includes forming a pressure-resistant layer on the sealing layer by a patterning process. The pressure-resistant layer is provided with at least one pressure sensing hole, the at least one pressure sensing hole is one-to-one corresponding to the at least one pressure sensing capacitor, and an orthographic projection of a pressure sensing hole on the base substrate is at least partially overlapped with an orthographic projection of the second electrode of a corresponding pressure sensing capacitor on the base substrate.

In an exemplary embodiment, when the pressure sensor includes at least one pressure sensing capacitor and at least one reference capacitor, forming the cavity between the first electrode and the second electrode of the at least one capacitor includes:
forming a cavity between the first electrode and the second electrode of the at least one pressure sensing capacitor, and forming a cavity and a support structure between the first electrode and the second electrode of the at least one reference capacitor.

Other aspects of the present disclosure may be comprehended after the drawings and the detailed descriptions are read and understood

### BRIEF DESCRIPTION OF DRAWINGS

Accompany drawings are used to provide understanding of technical solution of the present disclosure, and form a part of the specification. The accompany drawings and embodiments of the present disclosure are adopted to explain the technical solution of the present disclosure, and do not form limitations on the technical solution of the present disclosure.

FIG. 1 is a schematic diagram of a structure of a pressure sensor provided in an embodiment of the present disclosure.

FIG. 2 is a top view of a second electrode.

FIG. 3A is a first schematic diagram of a pressure sensor.

FIG. 3B is a second schematic diagram of a pressure sensor.

FIG. 3C is a third schematic diagram of a pressure sensor.

FIG. 4A is a first schematic diagram of another pressure sensor.

FIG. 4B is a second schematic diagram of another pressure sensor.

FIG. 4C is a third schematic diagram of another pressure sensor.

FIG. 5 is a schematic diagram of a structure of yet another pressure sensor.

FIG. 6 is a schematic diagram of connection of a pressure sensor.

FIG. 7 is a schematic diagram of connection of another pressure sensor.

FIG. 8 is a first schematic diagram of a structure of a pressure sensor including two capacitors.

FIG. 9A is a second schematic diagram of a structure of a pressure sensor including two capacitors.

FIG. 9B is a third schematic diagram of a structure of a pressure sensor including two capacitors.

FIG. 10 is a fourth schematic diagram of a structure of a pressure sensor including two capacitors.

FIG. 11A is a fifth schematic diagram of a structure of a pressure sensor including two capacitors.

FIG. 11B is a sixth schematic diagram of a structure of a pressure sensor including two capacitors.

FIG. 12 is a first schematic diagram of a film layer on which a second electrode of a pressure sensing capacitor is located.

FIG. 13 is a second schematic diagram of a film layer on which a second electrode of a pressure sensing capacitor is located.

FIG. 14 is a schematic diagram of connection of yet another pressure sensor.

FIG. 15 is a first schematic diagram of a structure of a pressure sensor including four capacitors.

FIG. 16A is a second schematic diagram of a structure of a pressure sensor including four capacitors.

FIG. 16B is a third schematic diagram of a structure of a pressure sensor including four capacitors.

FIG. 17 is a fourth schematic diagram of a structure of a pressure sensor including four capacitors.

FIG. 18A is a fifth schematic diagram of a structure of a pressure sensor including two capacitors.

FIG. 18B is a sixth schematic diagram of a structure of a pressure sensor including two capacitors.

FIG. 19 is a top view of a conductive film layer of a pressure sensor including four capacitors.

FIG. 20 is a schematic diagram of one of the conductive film layers in FIG. 19.

FIG. 21 is a schematic diagram of another conductive film layer in FIG. 19.

FIG. 22 is a first schematic diagram of a film layer on which second electrodes of two pressure sensing capacitors are located.

FIG. 23 is a second schematic diagram of a film layer on which second electrodes of two pressure sensing capacitors are located.

FIGS. 24a to 24h are flowcharts of manufacturing a pressure sensor provided in FIG. 8.

FIGS. 25a to 25d are flowcharts of manufacturing a pressure sensor provided in FIG. 9.

FIGS. 26a to 26e are flowcharts of manufacturing a pressure sensor provided in FIG. 10.

FIGS. 27a to 27c are flowcharts of manufacturing a pressure sensor provided in FIG. 11.

### DETAILED DESCRIPTION

To make the objectives, technical solutions, and advantages of the present disclosure clearer, the embodiments of the present disclosure will be described in detail below with reference to the accompany drawings. It is to be noted that implementation modes may be implemented in multiple different forms. Those of ordinary skills in the art can easily understand such a fact that implementation modes and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings in the embodiments of the present disclosure relate only to the structures involved in the embodiments of the present disclosure, and other structures may be described with reference to conventional designs.

Scales of the drawings in the present disclosure may be used as a reference in actual processes, but are not limited thereto. For example, a width-length ratio of a channel, a thickness and spacing of each film, and a width and spacing of each signal line may be adjusted according to actual needs. A quantity of pixels in a display substrate and a quantity of sub-pixels in each pixel are not limited to numbers shown in the drawings. The drawings described in the present disclosure are schematic structural diagrams only, and one mode of the present disclosure is not limited to shapes, numerical values, or the like shown in the drawings.

Ordinal numerals “first”, “second”, “third”, etc., in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside”, etc., indicating directional or positional relationships are used to illustrate positional relationships between the composition elements, not to indicate or imply that involved devices or elements are required to have specific orientations and be structured and operated with the specific orientations but only to easily and simply describe the present specification, and thus should not be understood as limitations on the present disclosure. The positional relationships between the constituent elements may be changed as appropriate according to a direction according to which each constituent element is described. Therefore, appropriate replacements based on situations are allowed, which is not limited to the expressions in the specification.

In the specification, unless otherwise specified and defined, terms “mounting”, “mutual connection”, and “connection” should be understood in a broad sense. For example, a connection may be fixed connection, or a detachable connection, or an integral connection; it may be a mechanical connection or an electrical connection; it may be a direct connection, or an indirect connection through middleware, or internal communication inside two elements. Those of ordinary skills in the art may understand specific meanings of the above terms in the present disclosure according to specific situations.

In the specification, “electrical connection” includes connection of composition elements through an element with a certain electrical action. An “element with a certain electrical action” is not particularly limited as long as electrical signals between the connected constituent elements may be sent and received. Examples of the “element with the certain electrical action” not only include an electrode and a wiring, but also include a switching element such as a transistor, a resistor, an inductor, a capacitor, another element with various functions, etc.

In the specification, “parallel” refers to a state in which an angle formed by two straight lines is −10° or more and 10° or less, and thus also includes a state in which the angle is −5° or more and 5° or less. In addition, “perpendicular” refers to a state in which an angle formed by two straight lines is 80° or more and 100° or less, and thus also includes a state in which the angle is 85° or more and 95° or less.

In the specification, a “film” and a “layer” are interchangeable. For example, a “conductive layer” may be replaced with a “conductive thin film” sometimes. Similarly, an “insulation film” may be replaced with an “insulation layer” sometimes.

In the specification, “provided in a same layer” refers to a structure formed by patterning two (or more than two) structures through a same patterning process, and their materials may be the same or different. For example, materials of precursors for forming multiple structures provided in a same layer are the same, and final materials may be the same or different.

Triangle, rectangle, trapezoid, pentagon, hexagon, etc. in this specification are not strictly defined, and they may be approximate triangle, rectangle, trapezoid, pentagon, hexagon, etc. There may be some small deformations caused by tolerance, and there may be chamfer, arc edge, deformation, etc.

In the present disclosure, “about” refers to that a boundary is not defined so strictly and numerical values within a range of process and measurement errors are allowed.

Absolute pressure sensors require an independently sealed cavity, and the pressure in the cavity is usually low. The processing process of an absolute pressure sensor is: forming a lower electrode plate, depositing a sacrificial layer on the lower electrode plate, depositing an upper electrode plate on the sacrificial layer, and forming release holes on the upper electrode plate to etch the sacrificial layer to form a cavity, and then sealing the release holes using thin film deposition technology to form a vacuum reference cavity. Formation of the cavity requires precise control over the release time of the sacrificial layer and the design of sufficiently numerous and densely distributed release holes. This may lead to low precision in controlling a size of the cavity of the pressure sensor and poor product consistency.

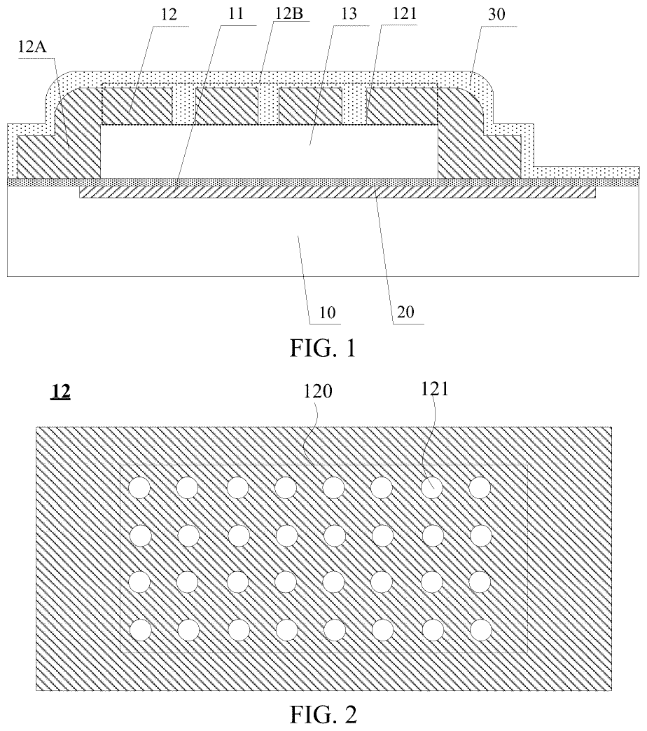

FIG. 1 is a schematic diagram of a structure of a pressure sensor provided in an embodiment of the present disclosure. As shown in FIG. 1, the pressure sensor provided in the embodiment of the present disclosure may include a base substrate 10 and at least one capacitor provided on the base substrate 10. One capacitor of the at least one capacitor may include a first electrode 11 and a second electrode 12 provided opposite to each other and insulated from each other, the second electrode 12 is located on a side of the first electrode 11 away from the base substrate 10, and a cavity 13 is provided between the first electrode 11 and the second electrode 12.

As shown in FIG. 1, an orthographic projection of the first electrode 11 on the base substrate 10 is at least partially overlapped with an orthographic projection of the second electrode on the base substrate 10, and an orthographic projection of an overlapping region of the first electrode 11 and the second electrode 12 on the base substrate is at least partially overlapped with an orthographic projection of the cavity 13 on the base substrate. That is, the orthographic projection of the first electrode 11 on the base substrate 10 is at least partially overlapped with the orthographic projection of the cavity 13 on the base substrate 10, and the orthographic projection of the second electrode 12 on the base substrate 10 is at least partially overlapped with the orthographic projection of the cavity 13 on the base substrate 10, such that a capacitor is formed between the first electrode 11 and the second electrode 12.

In the present disclosure, under pressure, the capacitor in the pressure sensor causes the second electrode 12 to deform toward the cavity 13, and a distance between the first electrode 11 and the second electrode 12 is decreased. Since a capacitance value is negatively correlated with the distance between the first electrode 11 and the second electrode 12, as the distance between the first electrode 11 and the second electrode 12 is decreased, the capacitance value of the pressure sensor is increased. A pressure value may be obtained by a corresponding relationship between the capacitance value and the pressure value.

In an exemplary embodiment, the cavity 13 may be a closed cavity. For example, the closed cavity may be a vacuum cavity.

In an exemplary embodiment, a cross-section of the cavity 13 may be square, rectangular, circular, or any shape that meets design requirements, which is not limited in any way in the present disclosure.

In an exemplary embodiment, as shown in FIG. 1, the second electrode 12 is provided around the cavity 13 to form a side wall, and is at least partially provided around a surface of the cavity 13 away from the first electrode. In the present disclosure, the second electrode 12 is provided around the cavity 13 to form a side wall, and at least partially provided around the surface of the cavity 13 away from the first electrode. A pattern of a boundary of the cavity may be defined by the second electrode, and there is no need to control the release time of the sacrificial layer and design sufficiently numerous and densely distributed release holes, thereby ensuring that the pattern of the boundary of the cavity is not affected by the release process, and improving the cavity size control accuracy and product consistency of the pressure sensor.

In an exemplary embodiment, as shown in FIG. 1, the first electrode 11 may be formed within the base substrate 10 and located on a surface of the base substrate 10.

In an exemplary embodiment, a material for making the base substrate 10 may include monocrystalline silicon.

In an exemplary embodiment, the first electrode may be formed by implanting ions into the base substrate 10 in the present disclosure, and a depth of implantation may be controlled by controlling process parameters of implantation, such as power, time, and the like, thereby achieving control of a thickness of the first electrode. Exemplarily, the ions may include boron, phosphorus, and arsenic.

In an exemplary embodiment, a shape of a top view of the first electrode may be square, rectangular, circular, or a shape that meets design requirements, which is not limited in any way in the present disclosure.

In the present disclosure, the first electrode is provided within the base substrate, which may not only reduce a thickness of the pressure sensor, but also avoid deposition of a conductive film used for forming the first electrode. Moreover, the first electrode is formed by a patterning process, which simplifies the manufacturing acts of the pressure sensor, and reduces the production cost.

In an exemplary embodiment, as shown in FIG. 1, the pressure sensor may further include an insulating dielectric layer 20 provided between the first electrode 11 and second electrode 12 of the at least one capacitor. The insulating dielectric layer 20 serves as an insulating layer between the first electrode 11 and the second electrode 12.

In an exemplary embodiment, a material for making the insulating dielectric layer 20 may be an insulating material and is unable to react with an etchant of the sacrificial layer. Exemplarily, the material for making the insulating dielectric layer 20 may include silicon nitride or silicon oxide.

In an exemplary embodiment, a material for making the sacrificial layer may include silicon oxide, low temperature glass, polysilicon, and phosphosilicate glass. When the material for making the sacrificial layer is low temperature glass or phosphosilicate glass, the etchant for the sacrificial layer may include an aqueous hydrogen fluoride solution. When the material for making the sacrificial layer is polysilicon, the etchant for the sacrificial layer is potassium hydroxide aqueous solution or tetramethyl ammonium hydroxide aqueous solution. Exemplarily, when the material for making the insulating dielectric layer is silicon oxide, in order to form a cavity, the insulating dielectric layer is etched, and the material for making the sacrificial layer may be low temperature glass, polysilicon, or phosphorosilicate glass.

FIG. 2 is a top view of a second electrode. As shown in FIG. 2, the second electrode 12 is provided with a release hole array 120, and the release hole array 120 include release holes 121 arranged in an array. An orthographic projection of the release hole array 120 on the base substrate is within a range of the orthographic projection of the cavity on the base substrate.

In an exemplary embodiment, a shape of the top view of the second electrode may be square, rectangular, circular, or a shape that meets design requirements, which is not limited in any way in the present disclosure. FIG. 2 shows a rectangle as an example.

In an exemplary embodiment, a quantity of release holes in the release hole array and a distance between the release holes may control a speed of cavity formation, specifically determined according to a process of the pressure sensor, which is not limited in any way in the present disclosure.

In an exemplary embodiment, the release hole array provided on the second electrode may not only form a cavity, but also avoid a reduction in a yield of the pressure sensor caused by an excessively large cross-sectional area of the second electrode.

In an exemplary embodiment, as shown in FIGS. 1 and 2, the orthographic projection of the release hole array 120 on the base substrate 10 is within the range of the orthographic projection of the cavity 13 on the base substrate 10. The etchant for the sacrificial layer may be released through the release holes 121.

In an exemplary embodiment, as shown in FIG. 1, the pressure sensor may further include a sealing layer 30 at least partially located on a side of the second electrode 12 of the at least one capacitor away from the base substrate 10. The sealing layer 30 may cause the cavity 13 to be referred to as a closed cavity.

In an exemplary embodiment, as shown in FIG. 1, an orthographic projection of the cavity 13 of the at least one capacitor on the base substrate 10 is located within a range of an orthographic projection of the sealing layer 30 on the base substrate 10, and the sealing layer 30 is at least partially filled in the release holes 121. Exemplarily, the sealing layer 30 may cover the base substrate 10.

In an exemplary embodiment, a material for making the sealing layer 30 may include at least one of silicon oxide and silicon nitride.

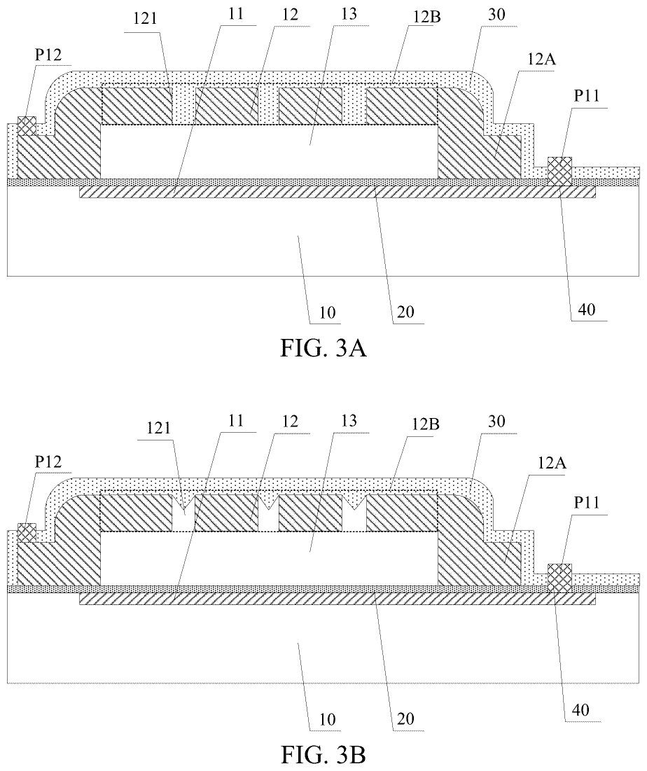

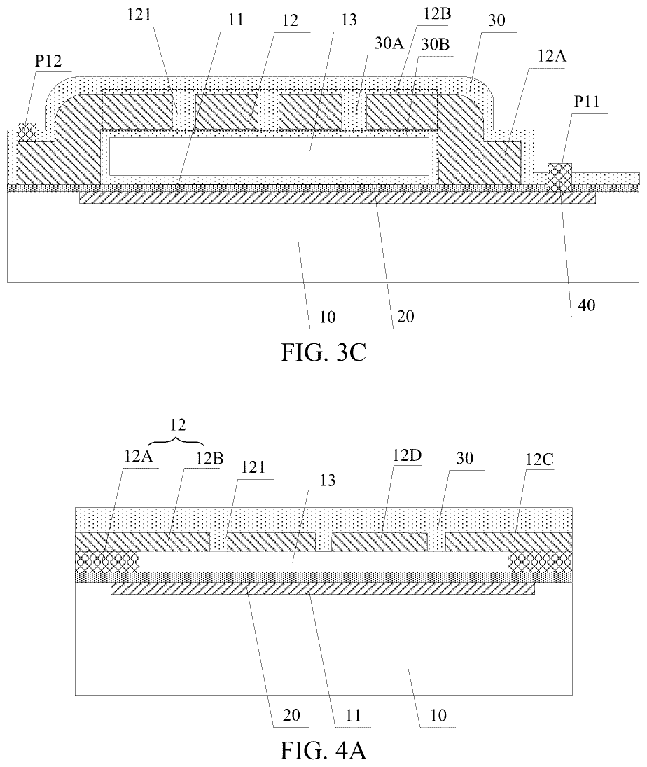

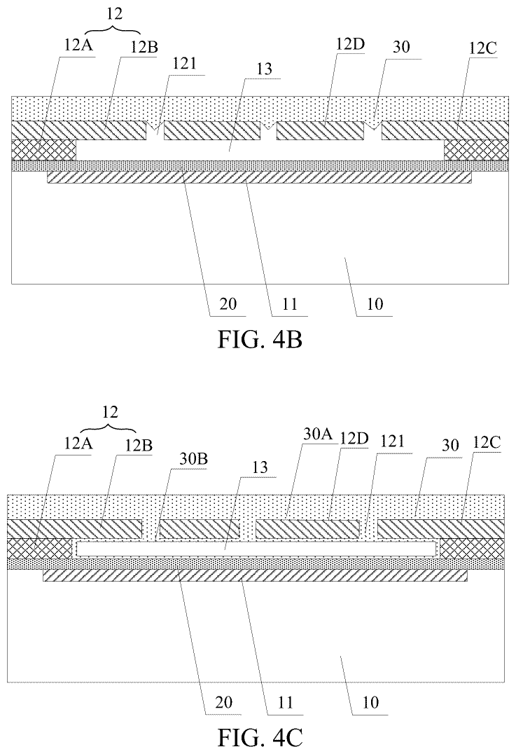

In an exemplary embodiment, FIG. 3A is a first schematic diagram of a pressure sensor, FIG. 3B is a second schematic diagram of a pressure sensor, FIG. 4A is a first schematic diagram of another pressure sensor, and FIG. 4B is a second schematic diagram of another pressure sensor. As shown in FIGS. 3A, 3B, 4A and 4B, a boundary of the cavity 13 is in contact with the insulating dielectric layer 20, the second electrode 22, and the sealing layer 30. That is, the insulating dielectric layer 20 serves as a lower boundary of the cavity 13, a portion of the second electrode 12 serves as a side boundary of the cavity 13, and the other portion of the second electrode 12 and the sealing layer filled in the release holes serve as an upper boundary of the cavity 13. FIG. 3A illustrates an example in which an entire region of the release hole is filled with the sealing layer. FIG. 3B illustrates an example in which a partial region of the release hole is filled with the sealing layer. Boundaries of the cavities in FIGS. 3A and 3B are determined by the shape of the second electrode.

In an exemplary embodiment, FIG. 3C is a third schematic diagram of a pressure sensor, and FIG. 4C is a third schematic diagram of another pressure sensor. As shown in FIGS. 3C and 4C, the sealing layer 30 may include a first sealing structure 30A and a second sealing structure 30B, and the first sealing structure 30A and the second sealing structure 30B may be of an integral structure. The first sealing structure 30A is located on a side of the second electrode 12 away from the base substrate 10, and is at least partially filled in the release holes. The orthographic projection of the cavity 13 of the at least one capacitor on the base substrate 10 is within a range of an orthographic projection of the first sealing structure 30A on the base substrate 10. Exemplarily, the first sealing structure 30A may cover the base substrate 10.

In an exemplary embodiment, as shown in FIGS. 3C and 4C, the second sealing structure 30B is located between the second electrode 12 and the insulating dielectric layer 20, and the cavity 13 is formed within the second sealing structure 30B. A boundary of the second sealing structure is determined by the second electrode 12, and the boundary of the cavity 13 is determined by the boundary of the second sealing structure 30B, that is, the boundary of the cavity 13 is determined by the second electrode 12.

In an exemplary embodiment, as shown in FIGS. 1 and 3A to 3C, the second electrode 12 may include a first sub-electrode 12A and a second sub-electrode 12B. The first sub-electrode 12A and the second sub-electrode 12B are provided in a same layer, and are formed by a same patterning process. An orthographic projection of the first sub-electrode 12A on the base substrate 10 is not overlapped with an orthographic projection of the second sub-electrode 12B on the base substrate 10.

In an exemplary embodiment, as shown in FIGS. 1 and 3A to 3C, the first sub-electrode 12A is provided around a side wall of the cavity 13, the second sub-electrode 12B is provided on a side of the cavity away from the base substrate 10, the orthographic projection of the cavity 13 on the base substrate 10 is at least partially overlapped with an orthographic projection of the second sub-electrode 12B on the base substrate 10, and the release hole array is provided on the second sub-electrode 12B.

In an exemplary embodiment, the pressure sensor provided in FIGS. 3A to 3C further includes a first conductive layer and a second conductive layer. The first conductive layer includes a first electrode of at least one capacitor, and the second conductive layer includes a second electrode of the at least one capacitor. The first conductive layer is located on a side of the insulating dielectric layer close to the base substrate, the second conductive layer is located on a side of the cavity away from the base substrate, and the second conductive layer is at least partially in direct contact with the insulating dielectric layer.

In an exemplary embodiment, as shown in FIGS. 4A to 4C, the second electrode 12 may include a first sub-electrode 12A and a second sub-electrode 12B connected with each other. The second sub-electrode 12B includes a first sub-connection portion 12C and a second sub-connection portion 12D. The first sub-electrode 12A is located on a side of the second sub-electrode 12B close to the base substrate 10.

In an exemplary embodiment, as shown in FIGS. 4A to 4C, an orthographic projection of the first sub-electrode 12A on the base substrate 10 is at least partially overlapped with an orthographic projection of the second sub-electrode 12B on the base substrate 10. The first sub-electrode 12A is provided around a side wall of the cavity 13, and the second sub-electrode 12B is provided on a side of the cavity 13 away from the base substrate 10. An orthographic projection of the first sub-connection portion 12C on the base substrate 10 is at least partially overlapped with the orthographic projection of the first sub-electrode 12A on the base substrate 10, the orthographic projection of the cavity 13 on the base substrate 10 is at least partially overlapped with an orthographic projection of the second sub-connection portion 12D on the base substrate 10, and the release hole array is provided on the second sub-connection portion 12D.

In an exemplary embodiment, the pressure sensor provided in FIGS. 4A to 4C further includes a first conductive layer, a second conductive layer and a third conductive layer. The first conductive layer includes a first electrode of at least one capacitor, the second conductive layer includes a first sub-electrode of a second electrode of at least one capacitor, and the third conductive layer includes a second sub-electrode of the second electrode of the at least one capacitor. The first conductive layer is located on a side of the insulating dielectric layer close to the base substrate, the second conductive layer is provided around the cavity to form a side wall, and is located on a side of the insulating dielectric layer away from the base substrate, and the third conductive layer is located on a side of the second conductive layer away from the base substrate.

In an exemplary embodiment, a material for making the first electrode 11 may include monocrystalline silicon doped with ions, and the ions include boron, phosphorus, and arsenic.

In an exemplary embodiment, a material for making the second electrode 12 may include low-resistance polysilicon or a metal.

In an exemplary embodiment, as shown in FIGS. 3A to 3C, the pressure sensor may further include a plurality of bonding pads located on a side of the sealing layer 30 away from the base substrate 10, and the plurality of bonding pads are respectively connected with the first electrode and the second electrode of the at least one capacitor.

In an exemplary embodiment, a material for making the plurality of bonding pads may include aluminum or gold.

Provision of a bonding pad layer in the present disclosure may realize input and detection of a signal of the pressure sensor, and there is no need to flatten a surface away from the sealing layer 30, which greatly reduces the process sequence and improves the yield of the pressure sensor.

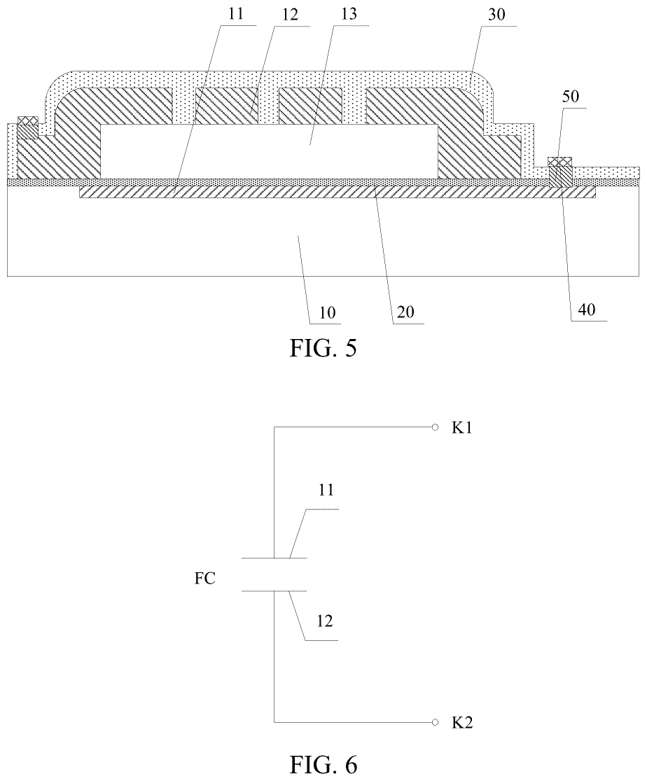

In an exemplary embodiment, FIG. 5 is a schematic diagram of a structure of yet another pressure sensor. As shown in FIG. 5, the pressure sensor may further include an adhesive layer 50. The adhesive layer includes a plurality of adhesive structures, the sealing layer is provided with a plurality of grooves, the plurality of adhesive structures are one-to-one corresponding to the plurality of grooves and one-to-one corresponding to the plurality of bonding pads, and an adhesive structure is provided in a corresponding groove and connected with a corresponding bonding pad and an electrode connected by the corresponding bonding pad.

In an exemplary embodiment, an orthographic projection of at least one adhesive structure on the base substrate coincides with an orthographic projection of the corresponding bonding pad on the base substrate.

In an exemplary embodiment, the adhesive layer 50 may include a conductive film layer, and a resistivity of a material for making the adhesive layer may be greater than a resistivity of a material for making the bonding pads. Provision of the adhesive layer in the present disclosure may improve the stability of the plurality of bonding pads and the electrodes connected therewith, and may improve the reliability of the pressure sensor.

In an exemplary embodiment, the material for making the adhesive layer may be a metal. Exemplarily, the material for making the adhesive layer may include titanium, chromium, or tantalum.

FIG. 6 is a schematic diagram of connection of a pressure sensor. In an exemplary embodiment, the at least one capacitor in the pressure sensor includes a pressure sensing capacitor FC, i.e., the pressure sensor includes only one pressure sensing capacitor. The second electrode in the pressure sensing capacitor is deformed under pressure, one electrode of the first electrode 11 and the second electrode 12 in the pressure sensing capacitor is connected with an interface K1, and the other electrode of the first electrode 11 and the second electrode 12 in the pressure sensing capacitor is connected with an interface K2.

In an exemplary embodiment, a DC voltage signal or an AC voltage signal is input at one of the interface K1 and the interface K2, a pressure sensing capacitor signal is detected at one of the interface K1 and the interface K2, and the pressure sensor may obtain a pressure value according to the pressure sensing capacitor signal.

In exemplary embodiments, FIGS. 3A to 3C and 4A to 4C all illustrate an example in which the pressure sensor includes one pressure sensing capacitor. As shown in FIGS. 3A to 3C and 4A to 4C, when the pressure sensor includes one pressure sensing capacitor, the plurality of bonding pads may include a first bonding pad P11 and a second bonding pad P12. The first bonding pad P11 is connected with the first electrode 11 of the pressure sensing capacitor, and the second bonding pad P12 is connected with the second electrode 12 of the pressure sensing capacitor.

In an exemplary embodiment, when the first electrode 11 in the pressure sensing capacitor is connected with the interface K1, and the second electrode 12 in the pressure sensing capacitor is connected with the interface K2, the first bonding pad P11 serves as the interface K1 and the second bonding pad P12 serves as the interface K2. Alternatively, when the first electrode 11 in the pressure sensing capacitor is connected with the interface K2, and the second electrode 12 in the pressure sensing capacitor is connected with the interface K1, the first bonding pad P11 serves as the interface K2 and the second bonding pad P12 serves as the interface K1.

Considering that an inherent parasitic capacitance of a single pressure sensing capacitor is relatively large and is greatly affected by a packaging stress, the at least one capacitor in the pressure sensor of the present disclosure may further include at least one pressure sensing capacitor and at least one reference capacitor. A deformation rate of the second electrode of a reference capacitor under pressure is 0.1% to 0.3% of a deformation rate of the second electrode of a pressure sensing capacitor under pressure. That is, the second electrode of the pressure sensing capacitor is deformed under pressure, while the second electrode of the reference capacitor is substantially undeformed under pressure. The present disclosure may improve the detection accuracy of the pressure sensor by canceling out a parasitic capacitance of the pressure sensing capacitor by a parasitic capacitance of the reference capacitor. Exemplarily, the at least one capacitor may include a pressure sensing capacitor and a reference capacitor, or the at least one capacitor may include two pressure sensing capacitors and two reference capacitors, which is not limited in any way in the present disclosure.

In an exemplary embodiment, a quantity of release holes included in the release hole array of the second electrode of the pressure sensing capacitor may be the same as a quantity of release holes included in the release hole array of the second electrode of the reference capacitor, or a quantity of release holes included in the release hole array of the second electrode of the pressure sensing capacitor may be greater than a quantity of release holes included in the release hole array of the second electrode of the reference capacitor.

In an exemplary embodiment, the first electrode of the at least one pressure sensing capacitor and the first electrode of the at least one reference capacitor are provided in a same layer, and the second electrode of the at least one pressure sensing capacitor and the second electrode of the at least one reference capacitor are provided in a same layer.

In an exemplary embodiment, the at least one capacitor in the pressure sensor may further include at least one pressure sensing capacitor and at least one reference capacitor, which may neither increase process sequence of the pressure sensor nor minimize a size of the pressure sensor.

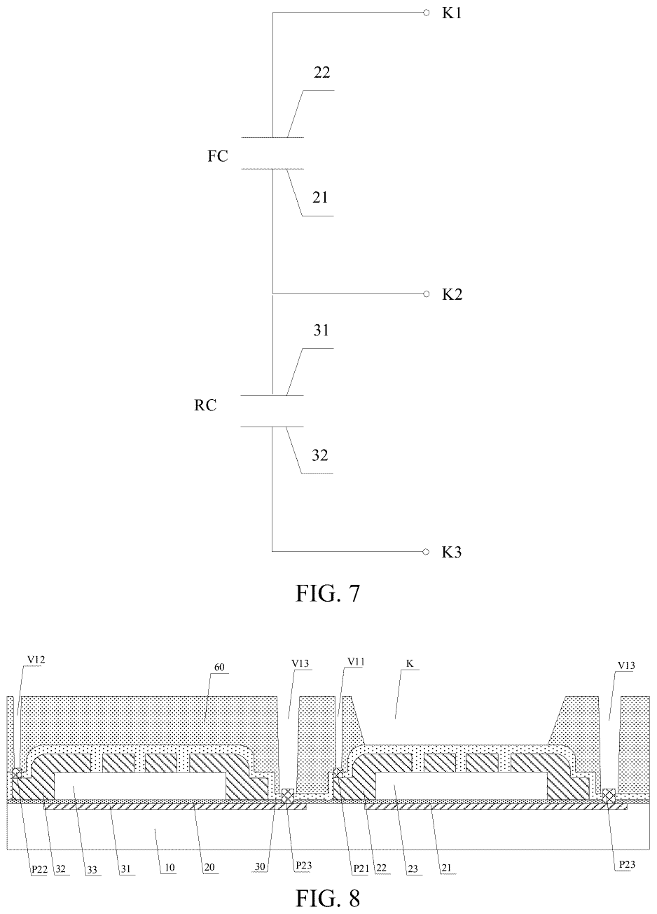

FIG. 7 is a schematic diagram of connection of another pressure sensor. As shown in FIG. 7, when the at least one capacitor includes a pressure sensing capacitor FC and a reference capacitor RC, the pressure sensing capacitor FC and the reference capacitor RC are connected in series, that is, the first electrode 21 of the pressure sensing capacitor FC and the first electrode 31 of the reference capacitor RC are connected with an interface K2, the second electrode 22 of the pressure sensing capacitor FC is connected with an interface K1, and the second electrode 32 of the reference capacitor RC is connected with an interface K3. A DC voltage signal or an AC voltage signal is input at the interface K1 and the interface K3, and a pressure sensing capacitor signal is detected at the interface K1 and the interface K2. According to the principle of charge conservation, a charge amount Q of the pressure sensing capacitor FC is equal to that of the reference capacitor RC, and a voltage value output by the pressure sensing capacitor FC satisfies U=Q/C, where C is a capacitance value of the pressure sensing capacitor FC. Under pressure, the second electrode 22 of the pressure sensing capacitor FC is deformed while the second electrode 32 of the reference capacitor RC is substantially undeformed, so that a capacitance of the pressure sensing capacitor FC is increased, and a voltage value between the interface K1 and the interface K2 connected by the pressure sensing capacitor FC is decreased, thereby reflecting a magnitude of the sensed pressure. The pressure sensor includes a pressure sensing capacitor and a reference capacitor in series, which may make the parasitic capacitance of the reference capacitor and the parasitic capacitance of the pressure sensing capacitor cancel each other out. In addition, since a stress introduced by the sealing layer is simultaneously applied to the reference capacitor and the reference capacitor with substantially a same processing technology, capacitance changes caused thereby also cancel each other out. Therefore, product stability and measurement accuracy of the pressure sensor are enhanced.

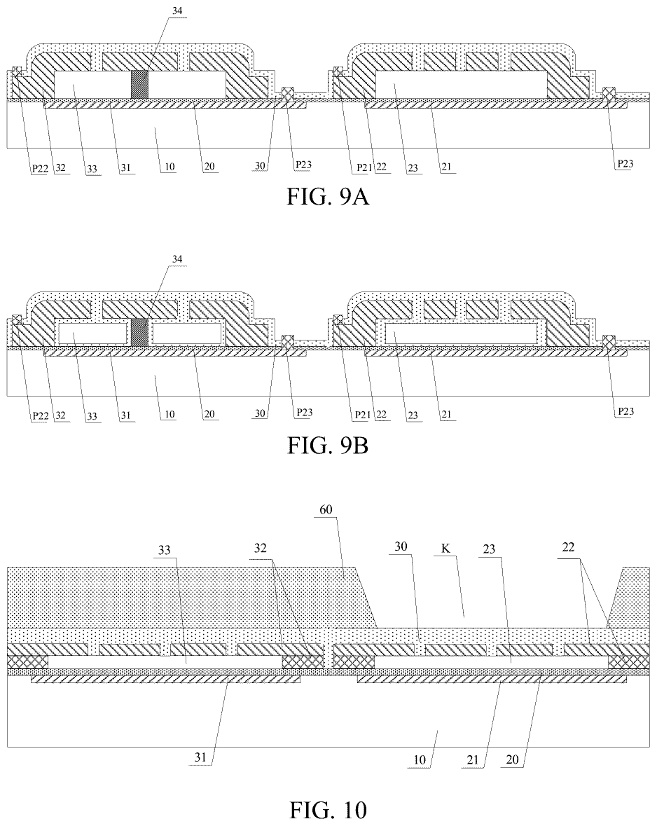

FIG. 8 is a first schematic diagram of a structure of a pressure sensor including two capacitors, FIG. 9A is a second schematic diagram of a structure of a pressure sensor including two capacitors, FIG. 9B is a third schematic diagram of a structure of a pressure sensor including two capacitors, FIG. 10 is a fourth schematic diagram of a structure of a pressure sensor including two capacitors, FIG. 11A is a fifth schematic diagram of a structure of a pressure sensor including two capacitors, and FIG. 11B is a sixth schematic diagram of a structure of a pressure sensor including two capacitors. As shown in FIGS. 8, 9A, 9B, 10, 11A and 11B, when a quantity of pressure sensing capacitor is one and a quantity of reference capacitor is one, the plurality of bonding pads include a first bonding pad P21, a second bonding pad P22, and a third bonding pad P23. The first bonding pad P21 is connected with the second electrode 22 of the pressure sensing capacitor FC, the second bonding pad P22 is connected with the second electrode 32 of the reference capacitor RC, and the third bonding pad P23 is connected with the first electrode 21 of the pressure sensing capacitor FC and the first electrode 31 of the reference capacitor RC. FIGS. 8 and 9A illustrate an example in which a structure of the capacitor is as shown in FIG. 3A, FIG. 9B illustrates an example in which a structure of the capacitor is as shown in FIG. 3C, and the structure of the capacitor may also be the structure as shown in FIG. 3B, and FIG. 10 and FIG. 11A illustrate an example in which a structure of the capacitor is as shown in FIG. 4A, and FIG. 11B illustrates an example in which a structure of the capacitor is as shown in FIG. 4C, and the structure of the capacitor may also be the structure as shown in FIG. 4B, which is not limited in any way in the present disclosure.

In an exemplary embodiment, the first bonding pad 21 serves as the interface K1, the second bonding pad 22 serves as the interface K3, and the third bonding pad serves as the interface K2.

In an exemplary embodiment, the first electrode 21 of the pressure sensing capacitor FC and the first electrode 31 of the reference capacitor RC are of an integral structure.

In an exemplary embodiment, the sealing layer 30 is provided with a via that exposes the second electrode 22 of the pressure sensing capacitor FC and a via that exposes the second electrode 32 of the reference capacitor RC. The first bonding pad P21 is connected with the second electrode 22 of the pressure sensing capacitor FC through the via that exposes the second electrode 22 of the pressure sensing capacitor FC, and the second bonding pad P22 is connected with the second electrode 32 of the reference capacitor RC through the via that exposes the second electrode 32 of the reference capacitor RC.

In an exemplary embodiment, the insulating dielectric layer 20 and the sealing layer 30 are provided with vias that expose the first electrode 21 of the pressure sensing capacitor FC and the first electrode 31 of the reference capacitor RC. The third bonding pad P23 is connected with the first electrode 21 of the pressure sensing capacitor FC and the first electrode 31 of the reference capacitor RC through the vias that expose the first electrode 21 of the pressure sensing capacitor FC and the first electrode 31 of the reference capacitor RC.

In order to realize that the second electrode of the pressure sensing capacitor is deformed under pressure, while the second electrode of the reference capacitor is substantially undeformed under pressure, the pressure sensor may, as shown in FIGS. 8 and 10, further include a pressure-resistant layer 60 located on a side of the plurality of bonding pads away from the base substrate 10 and covering the base substrate 10. An orthographic projection of the at least one reference capacitor on the base substrate is located within a range of an orthographic projection of the pressure-resistant layer 60 on the base substrate 10. The pressure-resistant layer 60 is provided with at least one pressure sensing hole that exposes the sealing layer 30, and the at least one pressure sensing hole is one-to-one corresponding to the at least one pressure sensing capacitor. That is, the present disclosure may include a pressure-resistant layer that may include a pressure sensing hole K, and an orthographic projection of the pressure sensing hole K on the base substrate 10 is at least partially overlapped with an orthographic projection of the second electrode 22 of the pressure sensing capacitor FC on the base substrate 10. Provision of the pressure sensing hole K in the present disclosure may cause the second electrode 22 of the pressure sensing capacitor FC to be deformed under pressure, and provision of the pressure-resistant layer 60 may cause the second electrode 32 of the reference capacitor RC to be substantially undeformed under pressure.

In an exemplary embodiment, a thickness of the pressure-resistant layer 60 may be greater than a thickness of the cavity of the at least one capacitor.

In an exemplary embodiment, a material for making the pressure-resistant layer 60 may include at least one of silicon oxide and silicon nitride.

In an exemplary embodiment, as shown in FIG. 8, the pressure-resistant layer 60 is further provided with a plurality of bonding pad holes that expose the plurality of bonding pads. The plurality of bonding pad holes include a first bonding pad hole V11, a second bonding pad hole V12, and a third bonding pad hole V13. The first bonding pad hole V11 exposes the first bonding pad P21, the second bonding pad hole V12 exposes the second bonding pad P22, and the third bonding pad hole V13 exposes the third bonding pad P23.

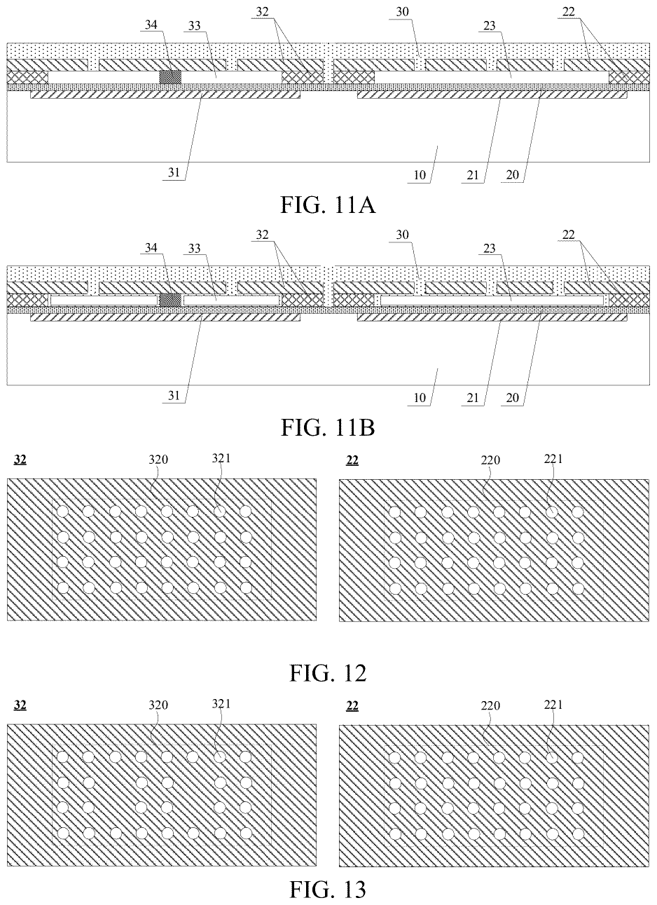

In an exemplary embodiment, FIG. 12 is a first schematic diagram of a film layer on which a second electrode of a pressure sensing capacitor is located. As shown in FIG. 12, a quantity of release holes included in the release hole array 220 of the second electrode 22 of the pressure sensing capacitor FC is the same as a quantity of release holes included in the release hole array 220 of the second electrode 32 of the reference capacitor RC. Exemplarily, the quantity and arrangement of the release holes 221 included in the release hole array of the second electrode 22 of the pressure sensing capacitor FC are the same as the quantity and arrangement of the release holes 321 included in the release hole array of the second electrode 32 of the reference capacitor RC. FIG. 12 is a schematic diagram of a film layer on which the second electrode of the pressure sensing capacitor is located when the pressure sensor includes a pressure-resistant layer.

In order to realize that the second electrode of the pressure sensing capacitor is deformed under pressure, while the second electrode of the reference capacitor is substantially undeformed under pressure, the reference capacitor may, as shown in FIGS. 9A, 9B, 11A and 11B, further include a support structure 34 provided between the second electrode 32 of the reference capacitor RC and the insulating dielectric layer 20. An orthographic projection of the support structure 34 on the base substrate 10 is overlapped with an orthographic projection of the second electrode 32 of the reference capacitor RC on the base substrate 10, and the cavity 33 of the reference capacitor RC is provided around the support structure 34. In the present disclosure, the reference capacitor RC is provided with the support structure 34, while the pressure sensing capacitor FC is not provided with a support structure, so that the pressure sensing capacitor FC is deformed under pressure, while the reference capacitor RC is not deformed under pressure.

In an exemplary embodiment, as shown in FIGS. 9A and 11A, when a structure of the capacitor is as shown in FIGS. 3A, 3B, 4A and 4B, a structure of the sealing layer is not provided around a side wall of the support structure of the reference capacitor.

In an exemplary embodiment, as shown in FIGS. 9B and 11B, when a structure of the capacitor is as shown in FIG. 3C or 4C, a second sealing structure of the sealing layer is provided around a side wall of the support structure of the reference capacitor.

In an exemplary embodiment, the support structure 34 and the cavity of the reference capacitor RC are formed by a same process, and the support structure 34 is an unetched sacrificial layer. A material for making the support structure 34 includes silicon oxide, low temperature glass, phosphosilicate glass, or polysilicon.

In an exemplary embodiment, a cross-section of the support structure 34 may be in a square, circular, or elliptical shape, which is not limited in any way in the present disclosure.

In an exemplary embodiment, FIG. 13 is a second schematic diagram of a film layer on which a second electrode of a pressure sensing capacitor is located. As shown in FIG. 13, a quantity of release holes 221 included in the release hole array 220 of the second electrode 22 of the pressure sensing capacitor FC is greater than a quantity of release holes 321 included in the release hole array 220 of the second electrode 32 of the reference capacitor RC, so that when the sacrificial layer is etched, the sacrificial layer in the pressure sensing capacitor FC is etched, while the sacrificial layer in the reference capacitor RC is not completely etched during the same period of time, and the unetched portion serves as the support structure 34 to support the second electrode of the reference capacitor RC, so that the reference capacitor RC is substantially undeformed under pressure. FIG. 13 is a schematic diagram of a film layer on which a second electrode of a pressure sensing capacitor is located when the reference capacitor includes a support structure.

In an exemplary embodiment, in order to realize that the second electrode of the pressure sensing capacitor is deformed under pressure, while the second electrode of the reference capacitor is substantially undeformed under pressure, the reference capacitor may further include a support structure 34 when the pressure sensor may include a pressure-resistant layer.

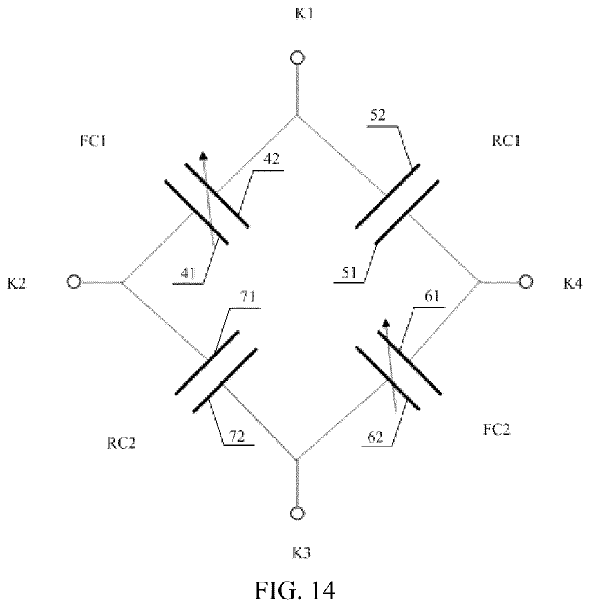

FIG. 14 is a schematic diagram of connection of yet another pressure sensor. As shown in FIG. 14, when at least one capacitor includes two pressure sensing capacitors and two reference capacitors, the two pressure sensing capacitors and the two reference capacitors may be connected in series and parallel to form a Wheatstone bridge. The two pressure sensing capacitors are a first pressure sensing capacitor FC1 and a second pressure sensing capacitor FC2, respectively, and the two reference capacitors are a first reference capacitor RC1 and a second reference capacitor RC2, respectively. The second electrode 42 of the first pressure sensing capacitor FC1 and the second electrode 52 of the first reference capacitor RC1 are respectively connected with an interface K1, the first electrode 41 of the first pressure sensing capacitor FC1 and the first electrode 71 of the second reference capacitor RC2 are respectively connected with an interface K2, the second electrode 62 of the second pressure sensing capacitor FC2 and the second electrode 72 of the second reference capacitor RC2 are respectively connected with an interface K3, and the first electrode 61 of the second pressure sensing capacitor FC2 and the first electrode 51 of the first reference capacitor RC1 are respectively connected with an interface K4. A DC voltage signal or an AC voltage signal is input at the interface K1 and the interface K3, and a pressure sensing capacitor signal is detected at the interface K2 and the interface K4. A signal strength of a pressure sensing capacitor signal detected by the pressure sensor including two pressure sensing capacitors and two reference capacitors is twice a signal strength of a pressure sensing capacitor signal detected by the pressure sensor including one pressure sensing capacitor and one reference capacitor. That is, detection sensitivity of the pressure sensor including two pressure sensing capacitors and two reference capacitors is significantly higher than detection sensitivity of the pressure sensor including one pressure sensing capacitor and one reference capacitor. Therefore, the pressure sensor including two pressure sensing capacitors and two reference capacitors has higher measurement accuracy and better product stability. In addition, since a plurality of capacitors are connected with only four interfaces, the complexity of signal processing is further reduced.

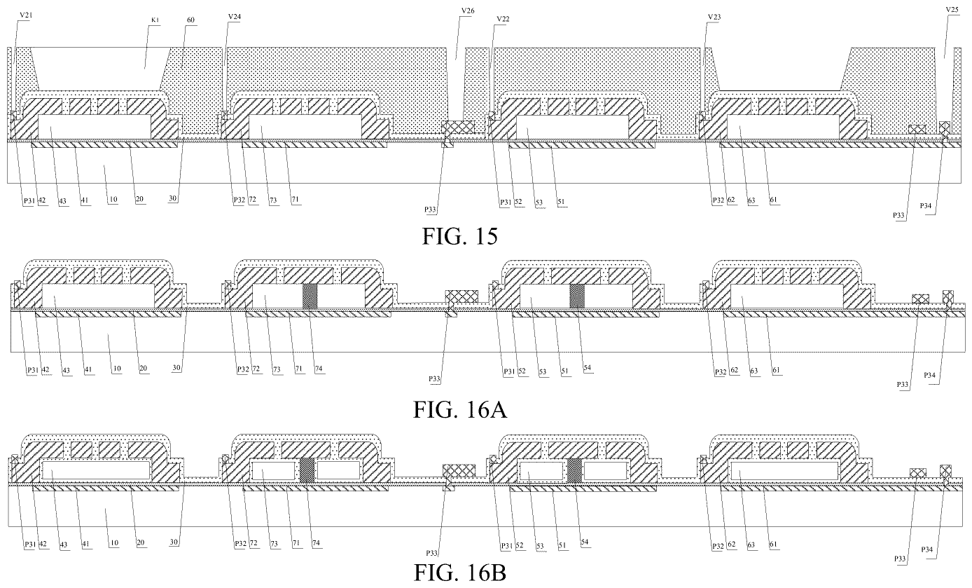

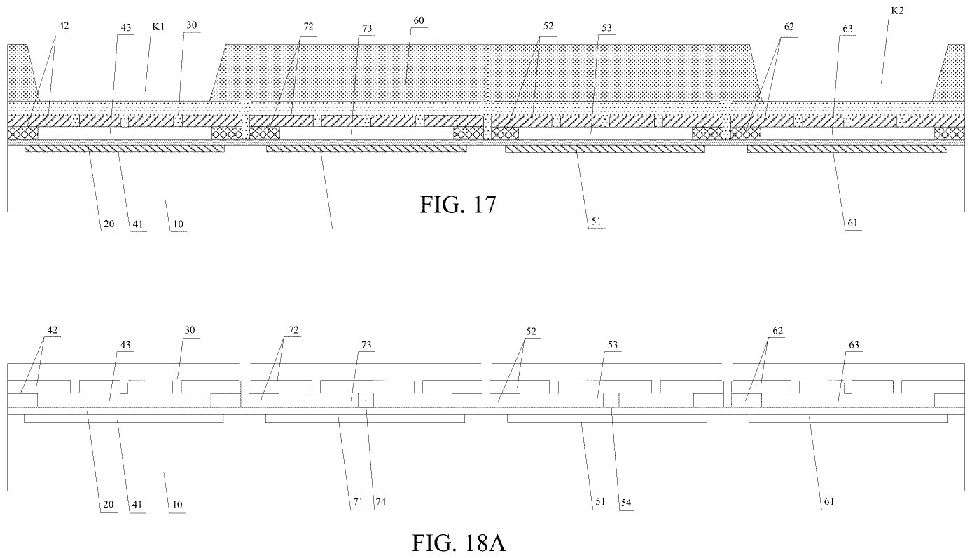

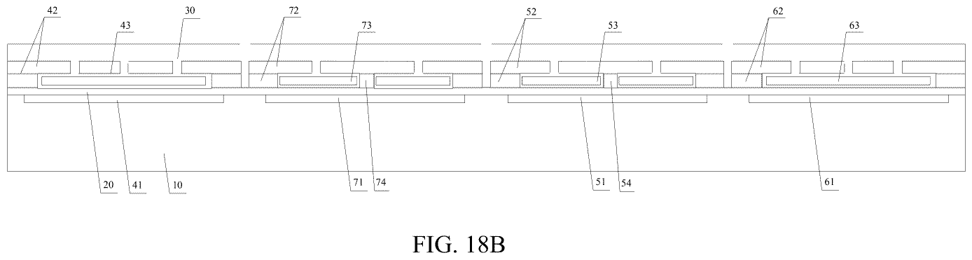

FIG. 15 is a first schematic diagram of a structure of a pressure sensor including four capacitors, FIG. 16A is a second schematic diagram of a structure of a pressure sensor including four capacitors, FIG. 16B is a third schematic diagram of a structure of a pressure sensor including four capacitors, FIG. 17 is a fourth schematic diagram of a structure of a pressure sensor including four capacitors, FIG. 18A is a fifth schematic diagram of a structure of a pressure sensor including two capacitors, FIG. 18B is a sixth schematic diagram of a structure of a pressure sensor including two capacitors, and FIG. 19 is a top view of a conductive film layer of a pressure sensor including four capacitors. FIGS. 15, 16A and 16B are cross-sectional views of FIG. 19 in an A-A direction. As shown in FIGS. 15, 16A, 16B and 19, in an exemplary embodiment, when a quantity of pressure sensing capacitors is two and a quantity of reference capacitors is two, the plurality of bonding pads include a first bonding pad P31, a second bonding pad P32, a third bonding pad P33, and a fourth bonding pad P44. The first bonding pad P31 is respectively connected with the second electrode 42 of the first pressure sensing capacitor FC1 and the second electrode 52 of the first reference capacitor RC1, the second bonding pad P32 is respectively connected with the second electrode 62 of the second pressure sensing capacitor FC2 and the second electrode 72 of the second reference capacitor RC2, the third bonding pad P33 is respectively connected with the first electrode 41 of the first pressure sensing capacitor FC1 and the first electrode 72 of the second reference capacitor RC2, and the fourth bonding pad P34 is respectively connected with the first electrode 51 of the first reference capacitor RC1 and the first electrode 61 of the second pressure sensing capacitor FC2. FIGS. 15 and 16A illustrate an example in which a structure of the capacitor is as shown in FIG. 3A, FIG. 16B illustrates an example in which a structure of the capacitor is as shown in FIG. 3C, and the structure of the capacitor may also be the structure as shown in FIG. 3B, and FIG. 17 and FIG. 18A illustrate an example in which a structure of the capacitor is as shown in FIG. 4A, and FIG. 18B illustrates an example in which a structure of the capacitor is as shown in FIG. 4C, and the structure of the capacitor may also be the structure as shown in FIG. 4B, which is not limited in any way in the present disclosure. In an exemplary embodiment, the second electrodes of the two reference capacitors and the two pressure sensing capacitors are provided with release hole arrays, which is not shown in FIG. 19 for the sake of simplifying FIG. 19.

In an exemplary embodiment, the first bonding pad P31 serves as the interface K1, the second bonding pad P32 serves as the interface K3, the third bonding pad P33 serves as the interface K2, and the fourth bonding pad P34 serves as the interface K4.

In an exemplary embodiment, as shown in FIG. 19, the first pressure sensing capacitor FC1, the second reference capacitor RC2, the first reference capacitor RC1, and the second pressure sensing capacitor FC2 are arranged in a first direction D1. Exemplarily, the first pressure sensing capacitor FC1, the second reference capacitor RC2, the first reference capacitor RC1, and the second pressure sensing capacitor FC2 are sequentially provided in the first direction D1, which is not limited in any way in the present disclosure.

In an exemplary embodiment, FIG. 20 is a schematic diagram of one of the conductive film layers in FIG. 19. As shown in FIG. 20, the first electrode 41 of the first pressure sensing capacitor FC1 and the first electrode 71 of the second reference capacitor RC2 are of an integral structure. The first electrode 61 of the second pressure sensing capacitor FC2 and the first electrode 51 of the first reference capacitor RC1 are of an integral structure.

In an exemplary embodiment, FIG. 21 is a schematic diagram of another conductive film layer in FIG. 19. As shown in FIG. 21, the second electrode 42 of the first pressure sensing capacitor FC1, the second electrode 62 of the second pressure sensing capacitor FC2, the second electrode 52 of the first reference capacitor RC1, and the second electrode 72 of the second reference capacitor RC2 are provided separately.

In an exemplary embodiment, as shown in FIGS. 20 and 21, the first electrode and the second electrode of the at least one capacitor each include a main body portion and a connecting portion. The main body portion has a rectangular shape, and the connecting portion has a rectangular shape. The connecting portion is located on a side of the main body portion and is connected with the main body portion, and an area of the connecting portion is smaller than an area of the main body portion. An orthographic projection of the main body portion of the first electrode 41 of the first pressure sensing capacitor FC1 on the base substrate is at least partially overlapped with an orthographic projection of the main body portion of the second electrode 42 of the first pressure sensing capacitor FC1 on the base substrate. An orthographic projection of the main body portion of the first electrode 61 of the second pressure sensing capacitor FC2 on the base substrate is at least partially overlapped with an orthographic projection of the main body portion of the second electrode 62 of the second pressure sensing capacitor FC2 on the base substrate, and an orthographic projection of the main body portion of the first electrode 51 of the first reference capacitor RC1 on the base substrate is at least partially overlapped with an orthographic projection of the main body portion of the second electrode 52 of the first reference capacitor RC1 on the base substrate. An orthographic projection of the main body portion of the first electrode 71 of the second reference capacitor RC2 on the base substrate is at least partially overlapped with an orthographic projection of the main body portion of the second electrode 72 of the second reference capacitor RC2 on the base substrate.

In an exemplary embodiment, the sealing layer 30 is provided with a via that exposes the second electrode 42 of the first pressure sensing capacitor FC, a via that exposes the second electrode 62 of the second pressure sensing capacitor FC2, a via that exposes the second electrode 52 of the first reference capacitor RC1, and a via that exposes the second electrode 72 of the second reference capacitor RC2. The first bonding pad P31 is connected with the second electrode 42 of the first pressure sensing capacitor FC1 through the via that exposes the second electrode 42 of the first pressure sensing capacitor FC, and is connected with the second electrode 52 of the first reference capacitor RC1 through the via that exposes the second electrode 52 of the first reference capacitor RC1. The second bonding pad P32 is connected with the second electrode 62 of the second pressure sensing capacitor FC2 through the via that exposes the second electrode 62 of the second pressure sensing capacitor FC2, and is connected with the second electrode 72 of the second reference capacitor RC2 through the via that exposes the second electrode 72 of the second reference capacitor RC2.

In an exemplary embodiment, the sealing layer 30 and the insulating dielectric layer 20 are provided with a via that exposes an integral structure of the first electrode 41 of the first pressure sensing capacitor FC1 and the first electrode 72 of the second reference capacitor RC2, and a via that exposes an integral structure of the first electrode 51 of the first reference capacitor RC1 and the first electrode 61 of the second pressure sensing capacitor FC2. The third bonding pad P33 is connected with the first electrode 41 of the first pressure sensing capacitor FC1 and the first electrode 72 of the second reference capacitor RC2 through the via that exposes the integral structure of the first electrode 41 of the first pressure sensing capacitor FC1 and the first electrode 72 of the second reference capacitor RC2, and the fourth bonding pad P34 is connected with the first electrode 51 of the first reference capacitor RC1 and the first electrode 61 of the second pressure sensing capacitor FC2 through the via that exposes the integral structure of the first electrode 51 of the first reference capacitor RC1 and the first electrode 61 of the second pressure sensing capacitor FC2.

In order to realize that the second electrode 42 of the first pressure sensing capacitor FC1 and the second electrode 62 of the second pressure sensing capacitor FC2 are deformed under pressure, while the second electrode 52 of the first reference capacitor RC1 and the second electrode 72 of the second reference capacitor RC2 are substantially undeformed under pressure, the pressure sensor may, as shown in FIGS. 15 and 17, further include a pressure-resistant layer 60 located on a side of the sealing layer away from the base substrate 10 and covering the base substrate 10. The pressure-resistant layer 60 is provided with at least one pressure sensing hole that exposes the sealing layer 30. As shown in FIGS. 15 and 17, the at least one pressure sensing hole includes a first pressure sensing hole K1 and a second pressure sensing hole K2. An orthographic projection of the first pressure sensing hole K1 on the base substrate 10 is at least partially overlapped with an orthographic projection of the second electrode 42 of the first pressure sensing capacitor FC1 on the base substrate 10. An orthographic projection of the second pressure sensing hole K2 on the base substrate 10 is at least partially overlapped with an orthographic projection of the second electrode 62 of the second pressure sensing capacitor FC2 on the base substrate 10. In the present disclosure, the first pressure sensing hole K1 and the second pressure sensing hole K2 are provided so that the second electrode 42 of the first pressure sensing capacitor and the second electrode 62 of the second pressure sensing capacitor are deformed under pressure, and the pressure-resistant layer 60 is provided so that the second electrode 52 of the first reference capacitor and the second electrode 72 of the second reference capacitor are substantially undeformed under pressure.

In an exemplary embodiment, as shown in FIG. 15, the pressure-resistant layer 60 is further provided with a plurality of bonding pad holes that expose the plurality of bonding pads. The plurality of bonding pad holes include a first bonding pad hole V21, a second bonding pad hole V22, a third bonding pad hole V23, and a fourth bonding pad hole V24. The first bonding pad hole V21 exposes the first bonding pad P31, the second bonding pad hole V22 exposes the second bonding pad P32, the third bonding pad hole V23 exposes the third bonding pad P33, and the fourth bonding pad hole V24 exposes the fourth bonding pad P34.

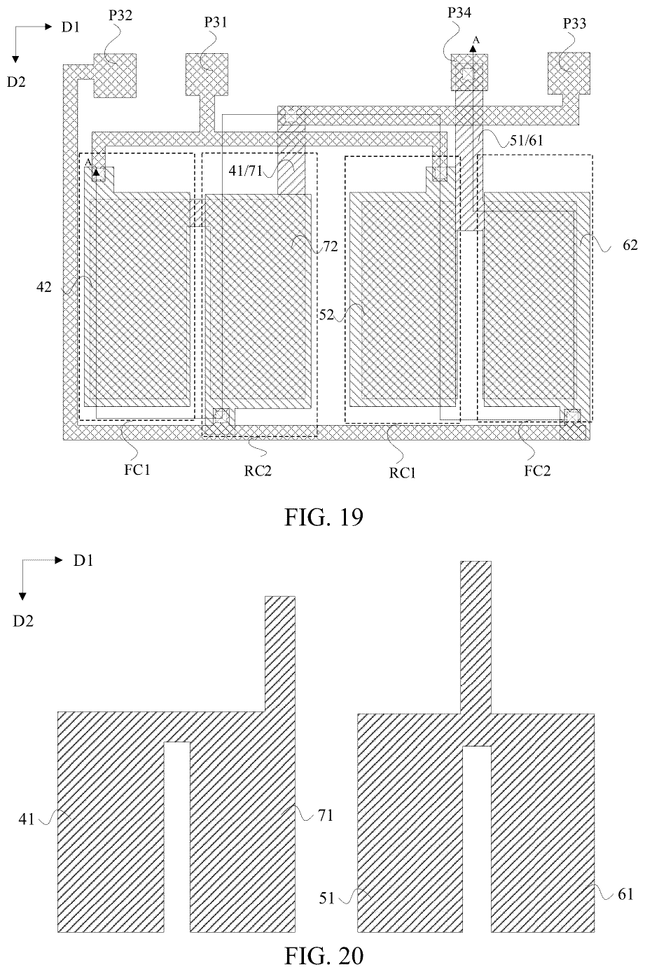

In an exemplary embodiment, FIG. 22 is a first schematic diagram of a film layer on which second electrodes of two pressure sensing capacitors are located. As shown in FIG. 22, a quantity of release holes included in the release hole array of the second electrode of the at least one pressure sensing capacitor is the same as a quantity of release holes included in the release hole array of the second electrode of the at least one reference capacitor. Exemplarily, quantities and arrangement of release holes 421 included in a release hole array 420 of the second electrode 42 of the first pressure sensing capacitor FC1 and release holes 621 included in a release hole array 620 of the second electrode 62 of the second pressure sensing capacitor FC2 are the same as quantities and arrangement of release holes 521 included in a release hole array 520 of the second electrode 52 of the first reference capacitor RC1 and release holes 721 included in a release hole array 720 of the second electrode 72 of the second reference capacitor RC2. FIG. 22 is a schematic diagram of a film layer on which the second electrode of the pressure sensing capacitor is located when the pressure sensor includes a pressure-resistant layer.

In order to realize that the second electrode of the pressure sensing capacitor is deformed under pressure, while the second electrode of the reference capacitor is substantially undeformed under pressure, the at least one reference capacitor may include a support structure. The support structure is provided between the second electrode of the reference capacitor and the insulating dielectric layer 20. An orthographic projection of the support structure on the base substrate 10 is overlapped with an orthographic projection of the second electrode of the reference capacitor on the base substrate 10, and the cavity of the reference capacitor is provided around the support structure. Exemplarily, as shown in FIGS. 16A, 16B, 18A and 18B, the first reference capacitor RC1 may further include a support structure 54, and the second reference capacitor RC2 may further include a support structure 74. The support structure 54 is provided between the second electrode 52 of the first reference capacitor RC1 and the insulating dielectric layer 20. An orthographic projection of the support structure 54 on the base substrate 10 is overlapped with an orthographic projection of the second electrode 52 of the first reference capacitor RC1 on the base substrate 10, and the cavity 53 of the first reference capacitor RC1 is provided around the support structure 54. The support structure 74 is provided between the second electrode 72 of the second reference capacitor RC2 and the insulating dielectric layer 20. An orthographic projection of the support structure 74 on the base substrate 10 is overlapped with an orthographic projection of the second electrode 72 of the first human reference capacitor RC3 on the base substrate 10, and the cavity 73 of the second reference capacitor RC3 is provided around the support structure 74. By providing the support structure 34 in the at least one reference capacitor, and providing no support structure in the at least one pressure sensing capacitor, the present disclosure realizes that the second electrode of the at least one reference capacitor is deformed under pressure, while the second electrode of the at least one reference capacitor is not deformed under pressure.

In an exemplary embodiment, as shown in FIGS. 16A and 18A, when a structure of the capacitor is as shown in FIGS. 3A, 3B, 4A and 4B, a structure of the sealing layer is not provided around a side wall of the support structure of the reference capacitor.

In an exemplary embodiment, as shown in FIGS. 16B and 18B, when a structure of the capacitor is as shown in FIG. 3C or 4C, a second sealing structure of the sealing layer is provided around a side wall of the support structure of the reference capacitor.

In an exemplary embodiment, the support structure and the cavity of the at least one reference capacitor are formed using a same process, and the support structure is an unetched sacrificial layer. A material for making the support structure includes silicon oxide, low temperature glass, phosphosilicate glass, or polysilicon.

In an exemplary embodiment, FIG. 23 is a second schematic diagram of a film layer on which second electrodes of two pressure sensing capacitors are located. As shown in FIG. 23, a quantity of release holes included in the release hole array of the second electrode of the at least one pressure sensing capacitor is greater than a quantity of release holes included in the release hole array of the second electrode of the at least one reference capacitor. Exemplarily, quantities of release holes 421 included in a release hole array 420 of the second electrode 42 of the first pressure sensing capacitor FC1 and release holes 621 included in a release hole array 620 of the second electrode 62 of the second pressure sensing capacitor FC2 is greater than quantities of release holes 521 included in a release hole array 520 of the second electrode 52 of the first reference capacitor RC1 and release holes 721 included in a release hole array 720 of the second electrode 72 of the second reference capacitor RC2. A quantity of release holes included in the release hole array of the second electrode of the at least one pressure sensing capacitor is greater than a quantity of release holes included in the release hole array of the second electrode of the at least one reference capacitor, so that when the sacrificial layer is etched, the sacrificial layer in the at least one pressure sensing capacitor is etched, while the sacrificial layer in the at least one reference capacitor is not completely etched during the same period of time, and the unetched portion serves as the support structure to support the second electrode of the at least one reference capacitor, so that the reference capacitor RC is substantially undeformed under pressure. FIG. 22 is a schematic diagram of a film layer on which a second electrode of a pressure sensing capacitor is located when the at least one reference capacitor includes a support structure.

In an exemplary embodiment, in order to realize that the second electrode of the at least one pressure sensing capacitor is deformed under pressure, while the second electrode of the at least one reference capacitor is substantially undeformed under pressure, the at least one reference capacitor may further include a support structure when the pressure sensor may include a pressure-resistant layer.

In an exemplary embodiment, an area of the cavity in the at least one capacitor close to a surface of the second electrode is within a range of 20 to 100 times a thickness of the cavity. In the present disclosure, the area of the cavity in the at least one capacitor close to the surface of the second electrode is within a range of 20 times to 100 times the thickness of the cavity, which may ensure that the capacitor may have a large deformation, thereby ensuring that the pressure sensor has a large sensitivity.

In an exemplary embodiment, when the at least one reference capacitor of the pressure sensor is provided with a support structure, because the pressure sensor is thin, it is possible to touch the pressure sensor during transportation, packaging, and testing. Therefore, some holes may be reserved outside an area of the base substrate where the pressure sensor is located to realize transportation and packaging.

The following is an illustrative example by a manufacturing process of a pressure sensor. A “patterning process” mentioned in the present disclosure includes photoresist coating, mask exposure, development, etching, photoresist stripping, etc., for a metal material, an inorganic material, or a transparent conductive material, and includes organic material coating, mask exposure, development, etc., for an organic material. Deposition may be any one or more of sputtering, evaporation, and chemical vapor deposition. The coating may be any one or more of spray coating, spin coating, and inkjet printing. A “thin film” refers to a layer of thin film made of a certain material on a base substrate using deposition, coating, or other processes. If the “thin film” does not need to be processed through a patterning process in the entire manufacturing process, the “thin film” may also be called a “layer”. If the “thin film” needs to be processed by the patterning process in the entire manufacturing process, the “thin film” is called a “thin film” before the patterning process is performed and is called a “layer” after the patterning process is performed. At least one “pattern” is contained in the “layer” which has been processed through the patterning process. “A and B are provided in a same layer” in the present disclosure means that A and B are formed simultaneously through a same patterning process, and a “thickness” of a film layer is a dimension of the film layer in a direction perpendicular to a display substrate. In an exemplary embodiment of the present disclosure, “an orthographic projection of B is within a range of an orthographic projection of A” or “an orthographic projection of A contains an orthographic projection of B” refers to that a boundary of the orthographic projection of B falls within a range of a boundary of the orthographic projection of A, or the boundary of the orthographic projection of A coincides with the boundary of the orthographic projection of B.

A manufacturing method for the pressure sensor provided in FIG. 8 includes acts S11 to S18.

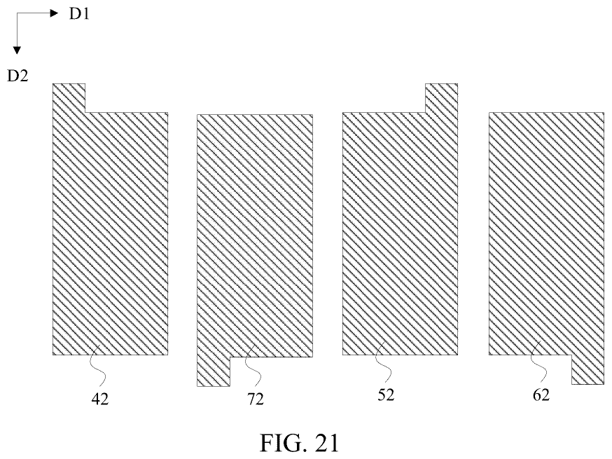

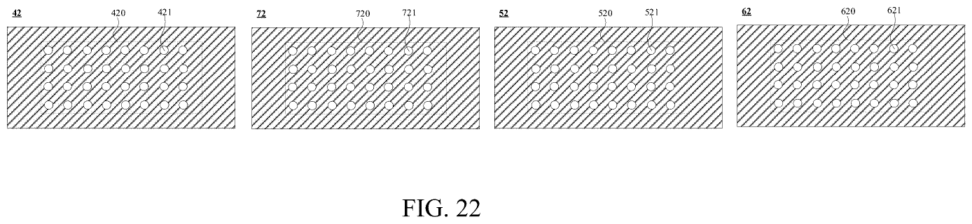

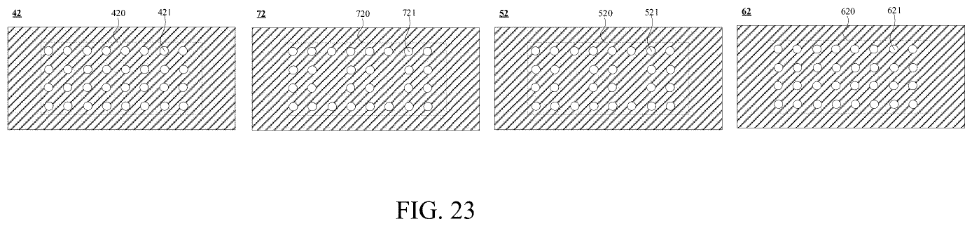

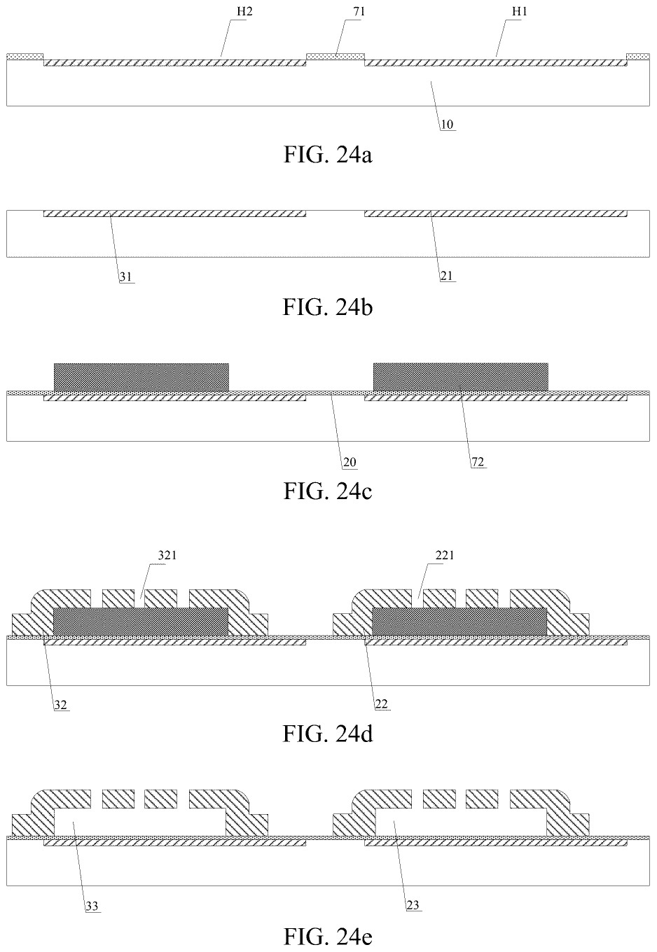

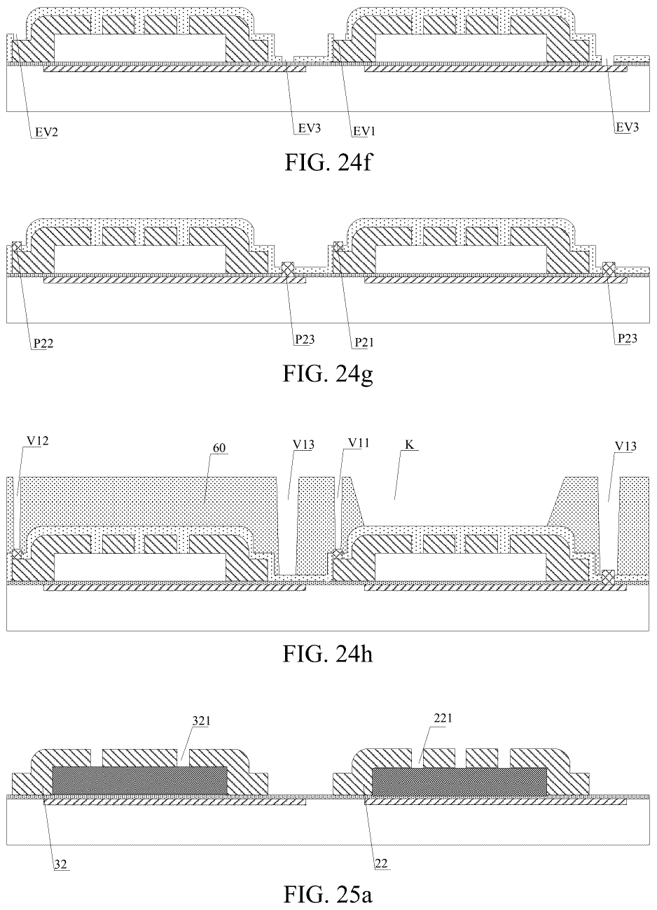

In act S11, a base substrate 10 is provided, a photoresist 71 is coated on the base substrate 10, and opening areas H1 and H2 are formed on the photoresist 71 by a patterning process, as shown in FIG. 24a.

In an exemplary embodiment, the base substrate 10 is made of monocrystalline silicon.

In act S12, ions are implanted into the opening areas H1 and H2, the base substrate into which the ions are implanted is used as a first electrode 21 of a pressure sensing capacitor and a first electrode 31 of a reference capacitor, and the photoresist is stripped off, as shown in FIG. 24b.

In an exemplary embodiment, low-temperature high-concentration ion implantation is accomplished using an ion implanter. An implanting dose may be from 3E15 per square centimeter to 1E16 per square centimeter.

Exemplarily, the ions may be boron, phosphorus or arsenic.

In act S13, an insulating dielectric thin film and a sacrificial thin film are sequentially deposited on the base substrate on which the first electrode of the pressure sensing capacitor and the first electrode of the reference capacitor are formed, and the sacrificial thin film is patterned by a patterning process to form an insulating dielectric layer 20 covering the base substrate 10 and a sacrificial layer 72 located at at least one capacitor on the insulating dielectric layer 20, as shown in FIG. 24c.

In an exemplary embodiment, a shape of the sacrificial layer 72 may be a boss structure, and a three-dimensional profile of the sacrificial layer 72 determines a profile of an inner wall of a cavity.

In an exemplary embodiment, a material for making the insulating dielectric layer 20 may include silicon nitride. The insulating dielectric layer 20 does not react with the etchant for the sacrificial layer.

In an exemplary embodiment, a material for making the sacrificial layer 72 may include silicon oxide, low temperature glass, or phosphorosilicate glass.

In act S14, a first conductive thin film is deposited on the base substrate on which the sacrificial layer 72 is formed, and the first conductive thin film is patterned by a patterning process to form a second electrode 22 of the pressure sensing capacitor and a second electrode 32 of the reference capacitor. The second electrode 22 of the pressure sensing capacitor is provided with release holes 221 arranged in an array, and the second electrode 32 of the reference capacitor is provided with release holes 321 arranged in an array, as shown in FIG. 24d.

In an exemplary embodiment, a material for making the first conductive thin film may include low-resistance polysilicon.

In an exemplary embodiment, a quantity and arrangement of the release holes 221 in the second electrode 22 of the pressure sensing capacitor are the same as a quantity and arrangement of the release holes 321 in the second electrode 32 of the reference capacitor.

In act S15, the base substrate on which the second electrode of the pressure sensing capacitor and the second electrode of the reference capacitor are formed is soaked in an etchant, the sacrificial layer is etched and released by the etchant to form a cavity 23 of the pressure sensing capacitor and a cavity 33 of the reference capacitor, and the base substrate on which the cavity 23 of the pressure sensing capacitor and the cavity 33 of the reference capacitor are formed is dried, as shown in FIG. 24e.

In an exemplary embodiment, since the sacrificial layer is surrounded by low-resistance polysilicon and the low-resistance polysilicon is not etched by the etchant, the base substrate on which the second electrode of the pressure sensing capacitor and the second electrode of the reference capacitor are formed may be soaked in the etchant for a long time, and the sacrificial layer may be thoroughly etched away by shaking to ensure that no residue remains in the cavity.

In an exemplary embodiment, the etchant is an aqueous hydrogen fluoride solution.

In act S16, a sealing thin film is deposited on the base substrate on which the cavity 23 of the pressure sensing capacitor and the cavity 33 of the reference capacitor are formed, and the sealing thin film is patterned by a patterning process to form a sealing layer 30, as shown in FIG. 24f.

In an exemplary embodiment, the sealing layer 30 covers the release holes of the second electrode of the pressure sensing capacitor and the release holes of the second electrode of the reference capacitor, thereby sealing the cavity of the pressure sensing capacitor and the cavity of the reference capacitor.

In an exemplary embodiment, the sealing layer 30 includes a plurality of vias, and the plurality of vias include a first electrode exposure via EV1, a second electrode exposure via EV2, and a third electrode exposure via EV3. The first electrode exposure via EV1 exposes the second electrode of the pressure sensing capacitor, the second electrode exposure via EV2 exposes the second electrode of the reference capacitor, and a dielectric layer in the third electrode exposure via EV3 is etched, and exposes the first electrode of the pressure sensing capacitor and the first electrode of the reference capacitor.

In an exemplary embodiment, a material for making the sealing layer 30 may include at least one of silicon oxide and silicon nitride.

In act S17, a second conductive thin film is deposited on the base substrate on which the sealing layer 30 is formed, and the second conductive thin film is patterned by a patterning process to form a plurality of bonding pads, as shown in FIG. 24g.

In an exemplary embodiment, the plurality of bonding pads include a first bonding pad P21, a second bonding pad P22, and a third bonding pad P23. The first bonding pad P21 is connected with the second electrode of the pressure sensing capacitor through the first electrode exposure via, the second bonding pad P22 is connected with the second electrode of the reference capacitor through the second electrode exposure via, and the third bonding pad P23 is connected with the first electrode of the pressure sensing capacitor and the first electrode of the reference capacitor through the third electrode exposure via.

In an exemplary embodiment, a material for making the bonding pads may be a metal, such as aluminum or gold. That is, a film layer on which the bonding pads are located is a metal conductive layer.

In an exemplary embodiment, annealing is required after deposition of the metal conductive thin film to make the metal conductive layer form good ohmic contact.

In an exemplary embodiment, an adhesive thin film may further be deposited before the second conductive thin film is deposited on the base substrate on which the sealing layer 30 is formed, and the adhesive thin film and the second conductive thin film are patterned by a patterning process to form an adhesive layer and a bonding pad layer on the adhesive layer.

In an exemplary embodiment, the adhesive layer may be a metal conductive layer, and a material for making the adhesive layer may be a metal, such as titanium, chromium, or tantalum.

In act S18, a pressure-resistant thin film is deposited on the base substrate on which the bonding pad layer is formed, and the pressure-resistant thin film is patterned by a patterning process to form a pressure-resistant layer 60 covering the base substrate, as shown in FIG. 24h.

In an exemplary embodiment, the pressure-resistant layer 60 may include a pressure-resistant hole K and a first via V11 to a third via V13. The pressure-resistant hole K exposes the sealing layer, and an orthographic projection of the pressure-resistant hole K on the base substrate is at least partially overlapped with an orthographic projection of the second electrode of the pressure sensing capacitor on the base substrate. The first via V11 exposes the first bonding pad, the second via V12 exposes the second bonding pad, and the third via V13 exposes the third bonding pad.

A manufacturing method for the pressure sensor provided in FIG. 9 includes acts S21 to S27.

Act 21 is the same as act S11, act S22 is the same as act S12, and act S23 is the same as act S13.

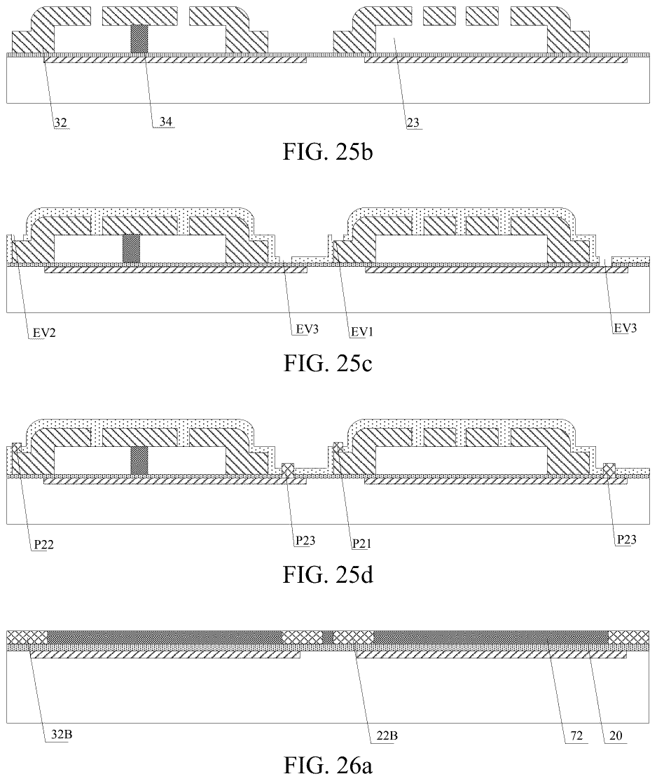

In act S24, a first conductive thin film is deposited on the base substrate on which the sacrificial layer is formed, and the first conductive thin film is patterned by a patterning process to form a second electrode 22 of the pressure sensing capacitor and a second electrode 32 of the reference capacitor. The second electrode 22 of the pressure sensing capacitor is provided with release holes 221 arranged in an array, and the second electrode 32 of the reference capacitor is provided with release holes 321 arranged in an array, as shown in FIG. 25a.

In an exemplary embodiment, a material for making the first conductive thin film may include low-resistance polysilicon.

In an exemplary embodiment, a quantity of the release holes 221 in the second electrode 22 of the pressure sensing capacitor is greater than a quantity of the release holes 321 in the second electrode 32 of the reference capacitor.

In act S25, the base substrate on which the second electrode of the pressure sensing capacitor and the second electrode of the reference capacitor are formed is soaked in an etchant, the sacrificial layer is etched and released by the etchant to form a cavity 23 of the pressure sensing capacitor and a cavity 33 and a support structure 34 of the reference capacitor, and the base substrate on which the cavity 23 of the pressure sensing capacitor and the cavity 33 of the reference capacitor are formed is dried, as shown in FIG. 25b.

In an exemplary embodiment, since the sacrificial layer is surrounded by low-resistance polysilicon, and the low-resistance polysilicon is not etched by the etchant, the base substrate on which the second electrode of the pressure sensing capacitor and the second electrode of the reference capacitor are formed may be soaked in the etchant within an allowable release time, thereby ensuring that no residue remains in the cavity of the pressure sensing capacitor. The cavity of the reference capacitor is further provided with a support structure 34. In an exemplary embodiment, the allowable release time may be obtained by calculating a release rate of the release hole array of the second electrode of the pressure sensing capacitor and a release rate of the release hole array of the second electrode of the reference capacitor, as well as by fiber observation.

In act S26, a sealing thin film is deposited on the base substrate on which the cavity of the pressure sensing capacitor and the cavity and the support structure of the reference capacitor are formed, and the sealing thin film is patterned by a patterning process to form a sealing layer 30, as shown in FIG. 25c.

In an exemplary embodiment, the sealing layer 30 covers the release holes of the second electrode of the pressure sensing capacitor and the release holes of the second electrode of the reference capacitor, thereby sealing the cavity of the pressure sensing capacitor and the cavity of the reference capacitor.

In an exemplary embodiment, the sealing layer 30 includes a plurality of vias, and the plurality of vias include a first electrode exposure via EV1, a second electrode exposure via EV2, and a third electrode exposure via EV3. The first electrode exposure hole EV1 exposes the second electrode of the pressure sensing capacitor, the second electrode exposure hole EV2 exposes the second electrode of the reference capacitor, and a dielectric layer in the third electrode exposure hole EV3 is etched, and exposes the first electrode of the pressure sensing capacitor and the first electrode of the reference capacitor.

In an exemplary embodiment, a material for making the sealing layer 30 may include at least one of silicon oxide and silicon nitride.

In act S27, a second conductive thin film is deposited on the base substrate on which the sealing layer 30 is formed, and the second conductive thin film is patterned by a patterning process to form a bonding pad layer, as shown in FIG. 25d.

In an exemplary embodiment, the bonding pad layer includes a first bonding pad P21, a second bonding pad P22, and a third bonding pad P23. The first bonding pad P21 is connected with the second electrode of the pressure sensing capacitor through the first electrode exposure via, the second bonding pad P22 is connected with the second electrode of the reference capacitor through the second electrode exposure via, and the third bonding pad P23 is connected with the first electrode of the pressure sensing capacitor and the first electrode of the reference capacitor through the third electrode exposure via.

In an exemplary embodiment, a material for making the bonding pads may be a metal, such as aluminum or gold. That is, a film layer on which the bonding pads are located is a metal conductive layer.

In an exemplary embodiment, annealing is required after deposition of the metal conductive thin film to make the metal conductive layer form good ohmic contact.

In an exemplary embodiment, an adhesive thin film may further be deposited before the second conductive thin film is deposited on the base substrate on which the sealing layer 30 is formed, and the adhesive thin film and the second conductive thin film are patterned by a patterning process to form an adhesive layer and a bonding pad layer on the adhesive layer.

In an exemplary embodiment, the adhesive layer may be a metal conductive layer, and a material for making the adhesive layer may be a metal, such as titanium, chromium, or tantalum.

A manufacturing method for the pressure sensor provided in FIG. 10 includes acts S31 to S37.

Act S31 is the same as act S11, and act S32 is the same as act S12.

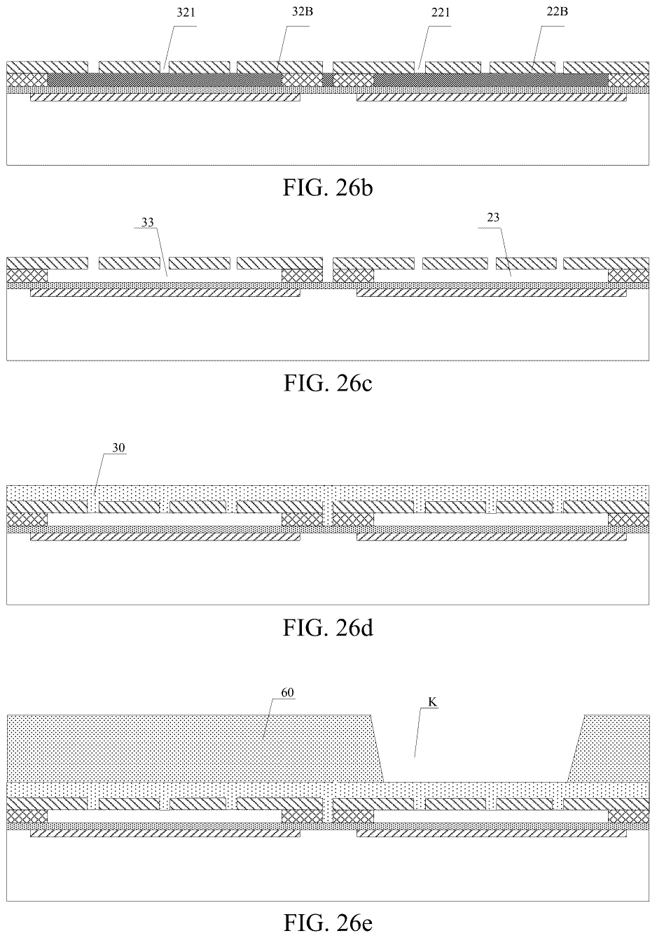

In act S33, an insulating dielectric thin film and a sacrificial thin film are deposited on the base substrate on which the first electrode 21 of the pressure sensing capacitor and the first electrode 31 of the reference capacitor are formed, a photoresist is coated on the sacrificial thin film, an opening area is formed on the photoresist by a patterning process, ions are implanted in the opening area to form an insulating dielectric layer 20 and a sacrificial layer 72, and the photoresist is stripped off. The sacrificial layer includes a doped region and a non-doped region. After the photoresist is peeled off, rapid thermal annealing or furnace tube annealing is performed to activate the ions located in the doped region so that the doped region is conductive to serve as a first sub-electrode 22A of the second electrode of the pressure sensing capacitor and a first sub-electrode 32A of the second electrode of the reference capacitor, as shown in FIG. 26a.

In an exemplary embodiment, the area where the non-doped region is located is an area for the cavity of the capacitor. A height of the non-doped region determines a height of the cavity of the capacitor.

In an exemplary embodiment, a material for making the sacrificial thin film may include polysilicon.

In an exemplary embodiment, a material for making the insulating dielectric layer 20 may include silicon oxide or silicon nitride. The insulating dielectric layer 20 does not react with the etchant for the sacrificial thin film.

In an exemplary embodiment, the etchant for the sacrificial thin film in the non-doped region is an aqueous potassium hydroxide solution or an aqueous tetramethyl ammonium hydroxide solution.

In act S34, a first conductive thin film is deposited on the base substrate on which the sacrificial layer 72 is formed, and the first conductive thin film is patterned by a patterning process to form a second sub-electrode 22B of the second electrode of the pressure sensing capacitor and a second sub-electrode 32B of the second electrode of the pressure sensing capacitor. The second sub-electrode 22B of the second electrode of the pressure sensing capacitor is provided with release holes 221 arranged in an array, and the second sub-electrode 32B of the second electrode 32 of the reference capacitor is provided with release holes 321 arranged in an array, as shown in FIG. 26b.

In an exemplary embodiment, a material for making the first conductive thin film may include low-resistance polysilicon or a metal. When the material for making the first conductive thin film is a metal, it may be platinum or chromium.

In an exemplary embodiment, a quantity of the release holes 221 in the second sub-electrode 22B of the second electrode of the pressure sensing capacitor is the same as a quantity of the release holes 321 in the second sub-electrode 32B of the second electrode of the reference capacitor.

In act S35, the base substrate on which the second sub-electrode of the second electrode of the pressure sensing capacitor and the second sub-electrode of the second electrode of the reference capacitor are formed is soaked in an etchant, the non-doped region of the sacrificial layer is etched and released by the etchant to form a cavity 23 of the pressure sensing capacitor and a cavity 33 of the reference capacitor, and the base substrate on which the cavity 23 of the pressure sensing capacitor and the cavity 33 of the reference capacitor are formed is dried, as shown in FIG. 26c.

In an exemplary embodiment, an etching rate of the etchant in the non-doped region of the sacrificial layer to the doped region of the sacrificial layer is only 1% to 2% of an etching rate of the etchant in the non-doped region of the sacrificial layer to the non-doped region of the sacrificial layer. When the etchant etches in the non-doped region of the sacrificial layer, and encounters the doped-region, the etching may stop automatically, enabling precise control of a boundary dimension of the cavity. Therefore, the base substrate on which the second sub-electrode of the second electrode of the pressure sensing capacitor and the second sub-electrode of the second electrode of the reference capacitor may be soaked in the etchant for a long time, and the sacrificial layer may be thoroughly eroded by shaking to ensure that no residue remains in the cavity

In act S36, a sealing thin film is deposited on the base substrate on which the cavity 23 of the pressure sensing capacitor and the cavity 33 of the reference capacitor are formed, and the sealing thin film is patterned by a patterning process to form a sealing layer 30, as shown in FIG. 26d.

In an exemplary embodiment, the sealing layer 30 covers the release holes of the second electrode of the pressure sensing capacitor and the release holes of the second electrode of the reference capacitor, thereby sealing the cavity of the pressure sensing capacitor and the cavity of the reference capacitor.

In an exemplary embodiment, a material for making the sealing layer 30 may include at least one of silicon oxide and silicon nitride.

In act S37, a pressure-resistant thin film is deposited on the base substrate on which the sealing layer is formed, and the pressure-resistant thin film is patterned by a patterning process to form a pressure-resistant layer 60 covering the base substrate, as shown in FIG. 26e.

In an exemplary embodiment, the pressure-resistant layer 60 includes a pressure-resistant hole K. The pressure-resistant hole K exposes the sealing layer, and an orthographic projection of the pressure-resistant hole K on the base substrate is at least partially overlapped with an orthographic projection of the second electrode of the pressure sensing capacitor on the base substrate.

A manufacturing method for the pressure sensor provided in FIG. 11 includes acts S41 to S46.

Act S41 is the same as act S31, act S42 is the same as act S32, and act S43 is the same as act S33.

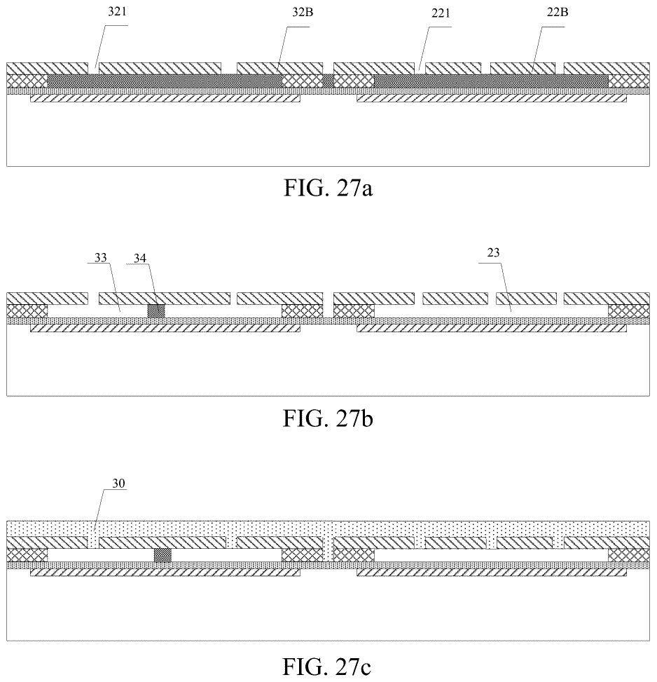

In act S44, a first conductive thin film is deposited on the base substrate on which the sacrificial layer is formed, and the first conductive thin film is patterned by a patterning process to form a second sub-electrode 22B of the second electrode of the pressure sensing capacitor and a second sub-electrode 32B of the second electrode of the pressure sensing capacitor. The second sub-electrode 22B of the second electrode of the pressure sensing capacitor is provided with release holes 221 arranged in an array, and the second sub-electrode 32B of the second electrode of the reference capacitor is provided with release holes 321 arranged in an array, as shown in FIG. 27a.

In an exemplary embodiment, a material for making the first conductive thin film may include low-resistance polysilicon.

In an exemplary embodiment, a quantity of the release holes 221 in the second sub-electrode 22B of the second electrode of the pressure sensing capacitor is greater than a quantity of the release holes 321 in the second sub-electrode 32B of the second electrode of the reference capacitor.

In act S45, the base substrate on which the second sub-electrode of the second electrode of the pressure sensing capacitor and the second sub-electrode of the second electrode of the reference capacitor are formed is soaked in an etchant, the non-doped region of the sacrificial layer is etched and released by the etchant to form a cavity 23 of the pressure sensing capacitor and a cavity 33 and a support structure 34 of the reference capacitor, and the base substrate on which the cavity 23 of the pressure sensing capacitor and the cavity 33 of the reference capacitor are formed is dried, as shown in FIG. 27b.

In an exemplary embodiment, the base substrate on which the second sub-electrode of the second electrode of the pressure sensing capacitor and the second sub-electrode of the second electrode of the reference capacitor are formed is soaked in the etchant within an allowable release time, thereby ensuring that no residue remains in the cavity of the pressure sensing capacitor. The cavity of the reference capacitor is further provided with a support structure 34. In an exemplary embodiment, the allowable release time may be obtained by calculating a release rate of the release hole array of the second electrode of the pressure sensing capacitor and a release rate of the release hole array of the second electrode of the reference capacitor, as well as by fiber observation.

In act S46, a sealing thin film is deposited on the base substrate on which the cavity of the pressure sensing capacitor and the cavity and the support structure of the reference capacitor are formed, and the sealing thin film is patterned by a patterning process to form a sealing layer 30, as shown in FIG. 27c.

In an exemplary embodiment, the sealing layer 30 covers the release holes of the second electrode of the pressure sensing capacitor and the release holes of the second electrode of the reference capacitor, thereby sealing the cavity of the pressure sensing capacitor and the cavity of the reference capacitor.

In an exemplary embodiment, a deposition process may include a plasma enhanced chemical vapor deposition process, a cryogenic chemical vapor deposition process, or a physical vapor deposition process, which is not limited in any way in the present disclosure.

An embodiment of the present disclosure further provides a pressure sensing assembly, including pressure sensors arranged d in an array.

The pressure sensors are pressure sensors provided in any one of the aforementioned embodiments, which is not limited in any way in the present disclosure.

An embodiment of the present disclosure further provides a method for manufacturing a pressure sensor, which is configured to manufacture a pressure sensor provided in any one of the aforementioned embodiments. The method for manufacturing a pressure sensor may include act S100 to act S300.

In act S100, a first electrode of at least one capacitor is formed.

In act S200, a second electrode of the at least one capacitor is formed.

In act S300, a cavity is formed between the first electrode and the second electrode of the at least one capacitor.

In an exemplary embodiment, the act S100 may include act S110 to act S120.

In act S110, a base substrate is provided.

In act S120, ions are implanted into a partial region of the base substrate to form the first electrode of the at least one capacitor.

In an exemplary embodiment, before act S200, the method for manufacturing the pressure sensor may further include act S400.

In act S400, an insulating dielectric layer is formed on the first electrode of the at least one capacitor.

In an exemplary embodiment, after act S300, the method for manufacturing the pressure sensor may further include act S500.

In act S500, a sealing layer is formed on the second electrode of the at least one capacitor by a patterning process.

In an exemplary embodiment, act S200 may include act S210 to act S220.

In act S210, a sacrificial layer is formed on the insulating dielectric layer by a patterning process.

In act S220, a second electrode of the at least one capacitor is formed on the sacrificial layer by a patterning process. The second electrode of the at least one capacitor is provided with a release hole array.

In an exemplary embodiment, act S300 may include etching the sacrificial layer by an etchant through the release hole array to form a cavity.

In an exemplary embodiment, the etchant may include an aqueous hydrofluoride solution. In an exemplary embodiment, act S200 may include act S230 to act S250.

In act S230, a sacrificial layer is formed on the insulating dielectric layer by a patterning process.

In act S240, ions are implanted into a partial region of the sacrificial layer to form a first sub-electrode of the second electrode of the at least one capacitor.

In an exemplary embodiment, the ions include boron, phosphorus and arsenic, and an implanting dose is in a range of 3E15 per square centimeter to 1E16 per square centimeter.

In act S250, a second sub-electrode of the second electrode is formed on the sacrificial layer implanted with the ions by a patterning process. The second sub-electrode is provided with a release hole array, and an orthographic projection of the release hole array on the base substrate is partially overlapped with an orthographic projection of the sacrificial layer which is not ion-implanted on the base substrate.

In an exemplary embodiment, act S300 may include act S330.

In act S330, the sacrificial layer which is not ion-implanted is etched by an etchant through the release hole array to form the cavity.

In an exemplary embodiment, the etchant may include an aqueous tetramethyl ammonium hydroxide solution or an aqueous potassium hydroxide solution.

In an exemplary embodiment, after act S300, the method for manufacturing the pressure sensor may further include act S600.

In act S600, a plurality of bonding pads are formed on the sealing layer by a patterning process.

In an exemplary embodiment, after act S300, the method for manufacturing the pressure sensor may further include act S700.

In act S700, an adhesive layer and a plurality of bonding pads are formed on the sealing layer by a patterning process in sequence.

In an exemplary embodiment, when the pressure sensor includes at least one pressure sensing capacitor and at least one reference capacitor, after act S600 or act S700, the method for manufacturing the pressure sensor further includes forming a pressure-resistant layer on the plurality of bonding pads by a patterning process.

In an exemplary embodiment, the pressure-resistance layer is provided with at least one pressure sensing hole, the at least one pressure sensing hole is one-to-one corresponding to the at least one pressure sensing capacitor, and an orthographic projection of a pressure sensing hole on the base substrate is at least partially overlapped with an orthographic projection of the second electrode of a corresponding pressure sensing capacitor on the base substrate.

In an exemplary embodiment, when the pressure sensor includes at least one pressure sensing capacitor and at least one reference capacitor, after act S500, the method for manufacturing the pressure sensor further includes forming a pressure-resistant layer on the sealing layer by a patterning process. The pressure-resistant layer is provided with at least one pressure sensing hole, the at least one pressure sensing hole is one-to-one corresponding to the at least one pressure sensing capacitor, and an orthographic projection of a pressure sensing hole on the base substrate is at least partially overlapped with an orthographic projection of the second electrode of a corresponding pressure sensing capacitor on the base substrate.

In an exemplary embodiment, when the pressure sensor includes at least one pressure sensing capacitor and at least one reference capacitor, act S300 may include forming a cavity between the first electrode and the second electrode of the at least one pressure sensing capacitor, and forming a cavity and a support structure between the first electrode and the second electrode of the at least one reference capacitor.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” the another element, or there may be an intermediate element.

Although the implementations of the present disclosure are disclosed above, the contents are only implementations used for ease of understanding of the present disclosure, but not intended to limit the present disclosure. Any of those skilled in the art of the present disclosure can make any modifications and variations in the implementation mode and details without departing from the spirit and scope of the present disclosure. However, the protection scope of the present disclosure should be subject to the scope defined by the appended claims.

1. A pressure sensor, comprising a base substrate and at least one capacitor provided on the base substrate, wherein one of the at least one capacitor comprises a first electrode and a second electrode provided opposite to each other and insulated from each other, the second electrode is located on a side of the first electrode away from the base substrate, and a cavity is provided between the first electrode and the second electrode;
an orthographic projection of the first electrode on the base substrate is at least partially overlapped with an orthographic projection of the second electrode on the base substrate, and an orthographic projection of an overlapping region of the first electrode and the second electrode on the base substrate is at least partially overlapped with an orthographic projection of the cavity on the base substrate; and
the second electrode is provided around the cavity to form a side wall, and is at least partially provided around a surface of the cavity away from the first electrode.

2. The pressure sensor according to claim 1, wherein the first electrode is formed within the base substrate and is located on a surface of the base substrate.

3. The pressure sensor according to claim 1, wherein the second electrode is provided with a release hole array, and the release hole array comprises release holes arranged in an array; and
an orthographic projection of the release hole array on the base substrate is within a range of the orthographic projection of the cavity on the base substrate.

4. The pressure sensor according to claim 3, wherein the second electrode comprises a first sub-electrode and a second sub-electrode connected with each other, and the first sub-electrode and the second sub-electrode are provided in a same layer; and
an orthographic projection of the first sub-electrode on the base substrate is not overlapped with an orthographic projection of the second sub-electrode on the base substrate, the first sub-electrode is provided around the side wall of the cavity, the second sub-electrode is provided on a side of the cavity away from the base substrate, the orthographic projection of the cavity on the base substrate is at least partially overlapped with a range of the orthographic projection of the second sub-electrode on the base substrate, and the release hole array is provided on the second sub-electrode.

5. The pressure sensor according to claim 3, wherein the second electrode comprises a first sub-electrode and a second sub-electrode connected with each other, the second sub-electrode comprises a first sub-connection portion and a second sub-connection portion, and the first sub-electrode is located on a side of the second sub-electrode close to the base substrate;
an orthographic projection of the first sub-electrode on the base substrate is at least partially overlapped with an orthographic projection of the second sub-electrode on the base substrate, the first sub-electrode is provided around the side wall of the cavity, and the second sub-electrode is provided on a side of the cavity away from the base substrate; and
an orthographic projection of the first sub-connection portion on the base substrate is at least partially overlapped with the orthographic projection of the first sub-electrode on the base substrate, the orthographic projection of the cavity on the base substrate is at least partially overlapped with a range of an orthographic projection of the second sub-connection portion on the base substrate, and the release hole array is provided on the second sub-connection portion.

6. The pressure sensor according to claim 1, further comprising an insulating dielectric layer provided between the first electrode and the second electrode of the at least one capacitor.

7. The pressure sensor according to claim 6, further comprising a sealing layer at least partially located on a side of the second electrode of the at least one capacitor away from the base substrate;
wherein an orthographic projection of the cavity of the at least one capacitor on the base substrate is located within a range of an orthographic projection of the sealing layer on the base substrate, and the sealing layer is at least partially filled in release holes.

8. The pressure sensor according to claim 7, wherein a boundary of the cavity is in contact with the insulating dielectric layer, the second electrode, and the sealing layer.

9. The pressure sensor according to claim 7, wherein the sealing layer comprises a first sealing structure and a second sealing structure, and the first sealing structure and the second sealing structure are of an integral structure; and
the first sealing structure is located on a side of the second electrode away from the base substrate, and at least partially filled in the release holes, the orthographic projection of the cavity of the at least one capacitor on the base substrate is located within a range of an orthographic projection of the first sealing structure on the base substrate, the second sealing structure is located between the second electrode and the insulating dielectric layer, and the cavity is formed in the second sealing structure.

10. The pressure sensor according to claim 1, further comprising a sealing layer and a plurality of bonding pads, wherein the sealing layer is located on a side of the second electrode of the at least one capacitor away from the base substrate, and the plurality of bonding pads are located on a side of the sealing layer away from the base substrate; and
the plurality of bonding pads are respectively connected with the first electrode and the second electrode of the at least one capacitor.

11. The pressure sensor according to claim 10, further comprising an adhesive layer, wherein the adhesive layer comprises a plurality of adhesive structures, the sealing layer is provided with a plurality of grooves, the plurality of adhesive structures are one-to-one corresponding to the plurality of grooves and one-to-one corresponding to the plurality of bonding pads, and an adhesive structure is provided in a corresponding groove and connected with a corresponding bonding pad; and
the adhesive layer comprises a conductive film layer, and a resistivity of a material for making the adhesive layer is greater than a resistivity of a material for making the bonding pads.

12. The pressure sensor according to claim 10, wherein the at least one capacitor comprises a pressure sensing capacitor, and the plurality of bonding pads comprise a first bonding pad and a second bonding pad; and
first bonding pads are respectively connected with a first electrode of the pressure sensing capacitor, and second bonding pads are respectively connected with a second electrode of the pressure sensing capacitor.

13. The pressure sensor according to claim 10, wherein the at least one capacitor comprises at least one pressure sensing capacitor and at least one reference capacitor, and a deformation rate of a second electrode of the reference capacitor under pressure is 0.1% to 0.3% of a deformation rate of a second electrode of the pressure sensing capacitor under pressure;
a quantity of release holes comprised in a release hole array of the second electrode of the pressure sensing capacitor is the same as a quantity of release holes comprised in a release hole array of the second electrode of the reference capacitor, or the quantity of the release holes comprised in the release hole array of the second electrode of the pressure sensing capacitor is greater than the quantity of the release holes comprised in the release hole array of the second electrode of the reference capacitor; and
a first electrode of the at least one pressure sensing capacitor and a first electrode of the at least one reference capacitor are provided in a same layer, and a second electrode of the at least one pressure sensing capacitor and a second electrode of the at least one reference capacitor are provided in a same layer.

14. The pressure sensor according to claim 13, wherein in a state where the quantity of the release holes comprised in the release hole array of the second electrode of the pressure sensing capacitor is the same as the quantity of the release holes comprised in the release hole array of the second electrode of the reference capacitor, the pressure sensor further comprises a pressure-resistant layer located on a side of the sealing layer away from the base substrate; and
an orthographic projection of the at least one reference capacitor on the base substrate is located within a range of an orthographic projection of the pressure-resistant layer on the base substrate, the pressure-resistant layer is provided with at least one pressure sensing hole that exposes the sealing layer, the at least one pressure sensing hole is one-to-one corresponding to the at least one pressure sensing capacitor, and an orthographic projection of the pressure sensing hole on the base substrate is at least partially overlapped with an orthographic projection of a second electrode of a corresponding pressure sensing capacitor on the base substrate.

15. The pressure sensor according to claim 13, wherein in a state where the quantity of the release holes comprised in the release hole array of the second electrode of the pressure sensing capacitor is greater than the quantity of the release holes comprised in the release hole array of the second electrode of the reference capacitor, the at least one reference capacitor further comprises a support structure provided between the second electrode of the at least one reference capacitor and the insulating dielectric layer; and
an orthographic projection of the support structure on the base substrate is at least partially overlapped with an orthographic projection of the second electrode of the reference capacitor on the base substrate, and the cavity of the reference capacitor is provided around the support structure.

16. The pressure sensor according to claim 13, wherein when a quantity of the pressure sensing capacitor is one and a quantity of the reference capacitor is one, the plurality of bonding pads comprise a first bonding pad, a second bonding pad, and a third bonding pad; and
first bonding pads are respectively connected with the second electrode of the pressure sensing capacitor, second bonding pads are respectively connected with the second electrode of the reference capacitor, and third bonding pads are respectively connected with the first electrode of the pressure sensing capacitor and the first electrode of the reference capacitor.

17. The pressure sensor according to claim 13, wherein when a quantity of pressure sensing capacitor is two and a quantity of reference capacitor is two, the plurality of bonding pads comprise a first bonding pad, a second bonding pad, a third bonding pad, and a fourth bonding pad; and
the first bonding pad is respectively connected with a second electrode of a first pressure sensing capacitor and a second electrode of a first reference capacitor, the second bonding pad is respectively connected with a second electrode of a second pressure sensing capacitor and a second electrode of a second reference capacitor, the third bonding pad is respectively connected with a first electrode of the first pressure sensing capacitor and a first electrode of the second reference capacitor, and the fourth bonding pad is respectively connected with a first electrode of the first reference capacitor and a first electrode of the second pressure sensing capacitor,
wherein the first pressure sensing capacitor, the second reference capacitor, the second pressure sensing capacitor and the second reference capacitor are provided in one direction.

18. (canceled)

19. The pressure sensor according to claim 1, wherein an area of a surface of the cavity in the at least one capacitor close to the second electrode is within a range of 20 to 100 times a thickness of the cavity.

20. The pressure sensor according to claim 1, further comprising at least one of a sealing layer, an adhesive layer, a bonding pad layer, a pressure-resistant layer, and a support structure; wherein
a material for making the base substrate comprises monocrystalline silicon;
a material for making the first electrode comprises monocrystalline silicon doped with ions, and the ions comprise boron, phosphorus and arsenic;
a material for making the second electrode comprises low-resistance polysilicon or a metal;
a material for making the insulating dielectric layer comprises silicon oxide or silicon nitride;
a material for making the sealing layer and the pressure-resistant layer comprises at least one of silicon oxide and silicon nitride;
a material for making the bonding pad layer comprises aluminum or gold;
a material for making the adhesive layer comprises titanium, chromium or tantalum; and
a material for making the support structure comprises silicon oxide, low temperature glass, phosphosilicate glass or polysilicon.

21. (canceled)

22. A method for manufacturing a pressure sensor configured to manufacture the pressure sensor according to claim 1, wherein the method comprises:
forming a first electrode of at least one capacitor;
forming a second electrode of the at least one capacitor; and
forming a cavity between the first electrode and the second electrode of the at least one capacitor.

23-34. (canceled)
